(19) United States
(12) Patent Application Publication
(10) Pub. No.: US 2025/0325853 A1
(43) Pub. Date: Oct. 23, 2025

(54) AERIAL FIREFIGHTING DELIVERY SYSTEM

(71) Applicant: Neptune Aviation Services, Inc., Missoula, MT (US)

(72) Inventor: Steve Bowyer, Tucson, AZ (US)

(21) Appl. No.: 19/187,917

(22) Filed: Apr. 23, 2025

Related U.S. Application Data
(60) Provisional application No. 63/637,757, filed on Apr. 23, 2024.

(51) Int. Cl. A62C 3/02; B64D 25/00

(52) U.S. Cl. CPC A62C 3/0235; B64D 25/00

(57) ABSTRACT

An aircraft for carrying and dispersing one or more firefighting agents includes a fuselage defining an interior space within the aircraft and bisected into a main deck and a lower deck. A pair of wings are coupled to the fuselage. A first storage tank is positioned within the main deck and forward of the pair of wings. A second storage tank is positioned within the main deck and aft of the pair of wings. At least a portion of first discharge ducting is positioned in the lower deck, where the first discharge ducting fluidly connects the first storage tank to discharge outlets disposed in an underbelly of the fuselage. At least a portion of second discharge ducting is positioned in the lower deck, where the second discharge ducting fluidly connects the second storage tank to discharge outlets disposed in the underbelly of the fuselage.

### CROSS REFERENCE TO RELATED APPLICATIONS

This application claims priority to U.S. Provisional Patent Application 63/637,757, filed Apr. 23, 2024, which is hereby incorporated by reference in its entirety.

### BACKGROUND

Equipment utilized for the firefighting of large terrain fires are required to operate with a high degree of precision in order to effectively deliver firefighting agents to an affected area. One highly utilized piece of equipment for this duty includes aircraft equipped with systems for storing and dispersing firefighting agents. In regard to firefighting planes, there are two main methods of storage of the firefighting agents: via tanks in the fuselage filled prior to a flight or via a fuselage filled mid-flight from a body of water. In the case of the former, the dispersion systems are generally limited in their ability to quickly provide high flow rates of the firefighting agents. These dispersion systems are also typically designed to minimize the airframe impact and ease certification, which has led to inefficient systems.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a partial cutaway side view of an aircraft housing an aerial firefighting delivery system in accordance with certain embodiments of the present disclosure;

FIG. 2 is an illustration of a shear force diagram comparing the shear force on a 1 g cargo load and a 1 g retardant tank load in accordance with certain embodiments of the present disclosure;

FIG. 3 is an illustration of a bending moment diagram comparing the bending moment of a 1 g cargo load and a 1 g retardant tank load in accordance with certain embodiments of the present disclosure;

FIG. 4A is an illustration of a storage tank installed in a fuselage of an aircraft in accordance with certain embodiments of the present disclosure;

FIG. 4B is an illustration of an alternative storage tank in accordance with certain embodiments of the present disclosure;

FIG. 4C is an illustration of a bottom perspective view of the alternative storage tank installed in a fuselage of an aircraft in accordance with certain embodiments of the present disclosure;

FIG. 5A is an illustration of a side view of an aircraft including an offset inlet duct in accordance with certain embodiments of the present disclosure;

FIG. 5B is an illustration of a zoomed-in view of the aircraft of FIG. 5A in accordance with certain embodiments of the present disclosure;

FIG. 5C is an illustration of a partial bottom view of an aircraft including an offset inlet duct and drop chutes in accordance with certain embodiments of the present disclosure;

FIG. 5D is an illustration of a zoomed-in view of the aircraft of FIG. 5C in accordance with certain embodiments of the present disclosure;

FIG. 6A is an illustration of a zoomed-in view of an underbelly of an aircraft including a pair of RADALT (radar altimeter) antennas in accordance with certain embodiments of the present disclosure;

FIG. 6B is an illustration of a zoomed-in view of one of the RADALT antennas of FIG. 6A surrounded by a fairing in accordance with certain embodiments of the present disclosure;

FIG. 6C is an illustration of a side view of the fairing of FIG. 6B in accordance with certain embodiments of the present disclosure;

FIG. 7 is an illustration of a flow rate diagram comparing flow rates of various drop scenarios in accordance with certain embodiments of the present disclosure;

FIG. 8A is an illustration of a diagrammatic view of a storage tank angled at a decline angle of 15 degrees in accordance with certain embodiments of the present disclosure;

FIG. 8B is an illustration of a diagrammatic view of a storage tank positioned in a level state in accordance with certain embodiments of the present disclosure;

FIG. 8C is an illustration of a diagrammatic view of a storage tank angled at an incline angle of 30 degrees in accordance with certain embodiments of the present disclosure;

FIG. 9 is an illustration of a diagram comparing an aircraft weight and the aircraft center of gravity for different flying stages of an exemplary aircraft in accordance with certain embodiments of the present disclosure;

FIG. 10 is an illustration of a diagram comparing an aircraft weight and the aircraft center of gravity for different flying stages of an additional exemplary aircraft in accordance with certain embodiments of the present disclosure;

FIG. 11A is an illustration of a partial cutaway side view of an aircraft housing an alternative embodiment of an aerial firefighting delivery system in accordance with certain embodiments of the present disclosure;

FIG. 11B is an illustration of a first storage tank of the aerial firefighting delivery system of FIG. 11A in accordance with certain embodiments of the present disclosure;

FIG. 11C is an illustration of a second storage tank of the aerial firefighting delivery system of FIG. 11A in accordance with certain embodiments of the present disclosure;

FIG. 11D is an illustration of an internal top view of the first storage tank of FIG. 11B in accordance with certain embodiments of the present disclosure;

FIG. 11E is an illustration of an internal top view of the first storage tank of FIG. 11C in accordance with certain embodiments of the present disclosure;

FIG. 11F is an illustration of a zoomed-in partial bottom view of the aircraft of FIG. 11A in accordance with certain embodiments of the present disclosure;

FIG. 11G is an illustration of a diagram comparing an aircraft weight and an aircraft center of gravity (CG) in accordance with certain embodiments of the present disclosure;

FIG. 12A is an illustration of a partial cutaway side view of an aircraft housing an alternative embodiment of an aerial firefighting delivery system in accordance with certain embodiments of the present disclosure;

FIG. 12B is an illustration of a first tank structure of the aerial firefighting delivery system of FIG. 12A in accordance with certain embodiments of the present disclosure;

FIG. 12C is an illustration of a second storage tank of the aerial firefighting delivery system of FIG. 12A in accordance with certain embodiments of the present disclosure;

FIG. 12D is an illustration of a zoomed-in partial bottom view of the aircraft of FIG. 12A in accordance with certain embodiments of the present disclosure;

FIG. 12E is an illustration of a diagram comparing an aircraft weight and an aircraft center of gravity (CG) in accordance with certain embodiments of the present disclosure;

FIG. 13A is an illustration of a plurality of engines affixed to multiple gate boxes in accordance with certain embodiments of the present disclosure;

FIG. 13B is an illustration of a top view of the engines and gate boxes of FIG. 13A in accordance with certain embodiments of the present disclosure;

FIG. 13C is an illustration of a single engine engaging a single gate box of FIG. 13A in accordance with certain embodiments of the present disclosure;

FIG. 13D is an illustration of an alternative configuration of the single engine and single gate box of FIG. 13C in accordance with certain embodiments of the present disclosure;

FIG. 14A is an illustration of a single engine engaging a single gate box in accordance with certain embodiments of the present disclosure;

FIG. 14B is an illustration of multiple engines engaging multiple gate boxes of FIG. 14A in accordance with certain embodiments of the present disclosure;

FIG. 15 is an illustration of a diagrammatic configuration of mechanically linked storage tanks in accordance with certain embodiments of the present disclosure;

FIG. 16A is an illustration of a partial cutaway side view of an aircraft housing an alternative embodiment of an aerial firefighting delivery system in accordance with certain embodiments of the present disclosure;

FIG. 16B is an illustration of a first storage tank of the aerial firefighting delivery system of FIG. 16A in accordance with certain embodiments of the present disclosure;

FIG. 16C is an illustration of a second storage tank of the aerial firefighting delivery system of FIG. 16A in accordance with certain embodiments of the present disclosure;

FIG. 16D is an illustration of a zoomed-in partial bottom view of the aircraft of FIG. 16A in accordance with certain embodiments of the present disclosure;

FIG. 16E is an illustration of a diagram comparing an aircraft weight and an aircraft center of gravity (CG) in accordance with certain embodiments of the present disclosure;

FIG. 17A is an illustration of a partial cutaway side view of an aircraft housing an alternative embodiment of an aerial firefighting delivery system in accordance with certain embodiments of the present disclosure;

FIG. 17B is an illustration of a first storage tank of the aerial firefighting delivery system of FIG. 17A in accordance with certain embodiments of the present disclosure;

FIG. 17C is an illustration of a second storage tank of the aerial firefighting delivery system of FIG. 17A in accordance with certain embodiments of the present disclosure;

FIG. 17D is an illustration of a zoomed-in partial bottom view of the aircraft of FIG. 17A in accordance with certain embodiments of the present disclosure;

FIG. 17E is an illustration of a diagram comparing an aircraft weight and an aircraft center of gravity (CG) in accordance with certain embodiments of the present disclosure;

FIG. 18 is an illustration of a perspective view of a butterfly valve in accordance with certain embodiments of the present disclosure;

FIG. 19 is an illustration of a computing machine and a system applications module in accordance with certain example embodiments;

FIG. 20, which is an illustration of a diagrammatic view of a delivery control system electrically connected to a flight station interface in accordance with certain embodiments of the present disclosure;

FIG. 21 is an illustration of a diagrammatic view of a firefighting agent storage system in accordance with certain embodiments of the present disclosure;

FIG. 22 is an illustration of a diagrammatic view of a firefighting agent delivery system in accordance with certain embodiments of the present disclosure;

FIG. 23 is an illustration of a diagrammatic view of a firefighting agent filling/draining system in accordance with certain embodiments of the present disclosure; and

FIG. 24, which is an illustration of a diagrammatic view of a firefighting agent leakage management system in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present invention relates generally to firefighting aircraft, and more particularly to delivery systems housed in aerial firefighting aircraft for carrying and dispersing firefighting agents. For the purposes of this disclosure, it is understood that any aircraft disclosed depicted in a side view includes a pair of wings that are generally symmetrical. The term “firefighting agent” is used herein to describe any type of medium that can be utilized to put out fires and can include, for example, fire retardant or water.

The teachings of certain embodiments of the present disclosure allow the implementation of an improved aerial firefighting delivery system that utilizes a tank design that is proven to exhibit salient performance margins. As a whole, the system is configured to embody at least: tanks considered to have a large firefighting agent capacity (for example, 4500-5000 gallons), fly-by-wire technology for safety and mission efficiency, an optimized and high-performing drop system that produces a salient dispersion of firefighting agent, and hardware and software that provides low modification costs, life cycle costs, and cost per gallon of firefighting agent dispensed.

The embodiments disclosed of an aerial firefighting delivery system is configured to include components capable of collectively meeting stringent requirements from multiple agencies. These requirements are embodied within and are upheld by multiple contracts, certificate procedures, and agencies and include, but are not limited to: US Forest Service (USFS) IAB requirements, USFS Contract Structural Integrity Program requirements, USFS MATOC contract requirements, and FAA Supplemental Type Certificate Procedures. In regard to the USFS IAB, requirements include at least: a delivery density of at least 8 GPC at drop airspeeds of 1.2 VS. In regard to the USFS IAB requirements, requirements for approval include at least: a firefighting agent minimum flow rate of at least 1125 US gallons per second (4260 l/sec). Further in regard to the USFS IAB requirements, for air-ground communication purposes, requirements include at least: an installation and integration of an FM transceiver within an audio system. In regard to the USFS Contract Structural Integrity Program requirements, these requirements contain the baseline airworthiness standards and can be found in the following publication: “USDA—Forest Service, Special Mission Airworthiness Assurance Guide,” released on Nov. 6, 2015, which is hereby incorporated by reference in its entirety herein.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Unless otherwise indicated, all numbers expressing quantities of components, properties such as center of gravity, shear force, bending moment, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Presented herein is an aircraft for carrying and dispersing firefighting agents. The aircraft comprises a fuselage defining an interior space within the aircraft; the fuselage is also bisected into a main deck and a lower deck. A pair of wings are coupled to the fuselage, where a first wing is disposed on a first side of the fuselage and a second wing is disposed on a second side of the fuselage. A first storage tank is positioned within the main deck and forward of the pair of wings while a second storage tank is positioned within the main deck and aft of the pair of wings. A first discharge ducting is positioned in the lower deck and fluidly connects the first storage tank to a first plurality of discharge outlets disposed in an underbelly of the fuselage. A second discharge ducting is positioned in the lower deck and fluidly connects the second storage tank to a second plurality of discharge outlets disposed in the underbelly of the fuselage.

Also presented herein is an aerial firefighting delivery system. The system comprises a first storage tank positioned within a main deck of an aircraft and forward of a pair of wings of the aircraft. A second storage tank is positioned within the main deck and aft of the pair of wings. A first discharge ducting is positioned in a lower deck of the aircraft, where the first discharge ducting fluidly connects the first storage tank to a first plurality of discharge outlets disposed in an underbelly of the aircraft. A second discharge ducting is positioned in the lower deck, where the second discharge ducting fluidly connects the second storage tank to a second plurality of discharge outlets disposed in the underbelly.

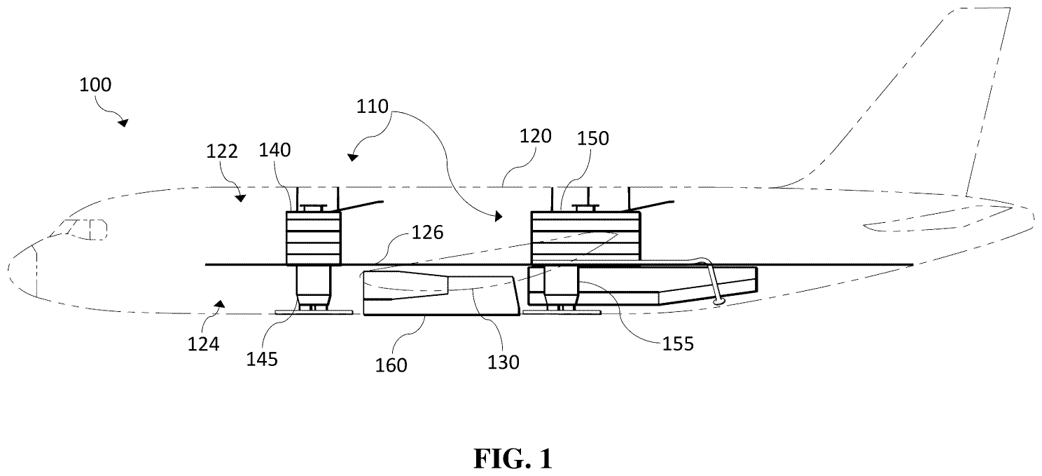

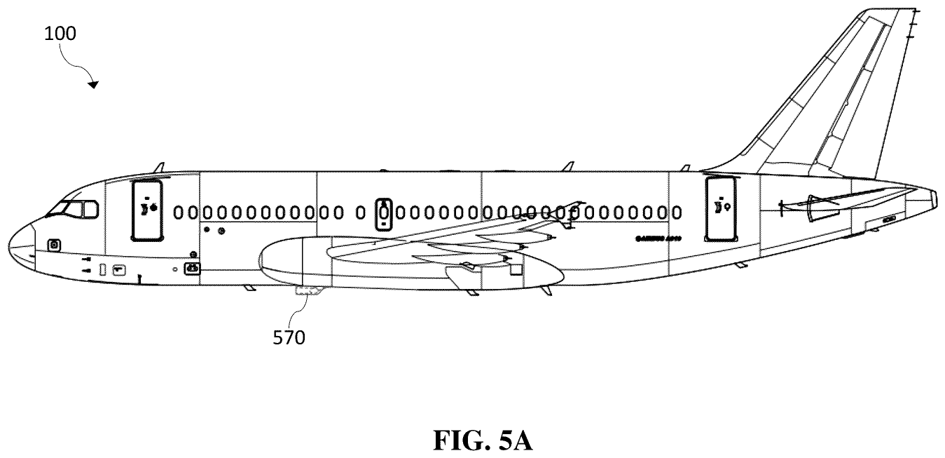

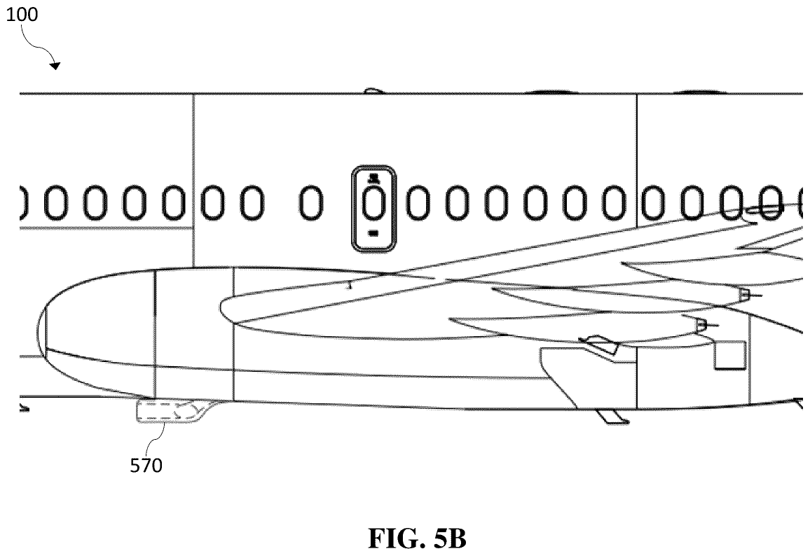

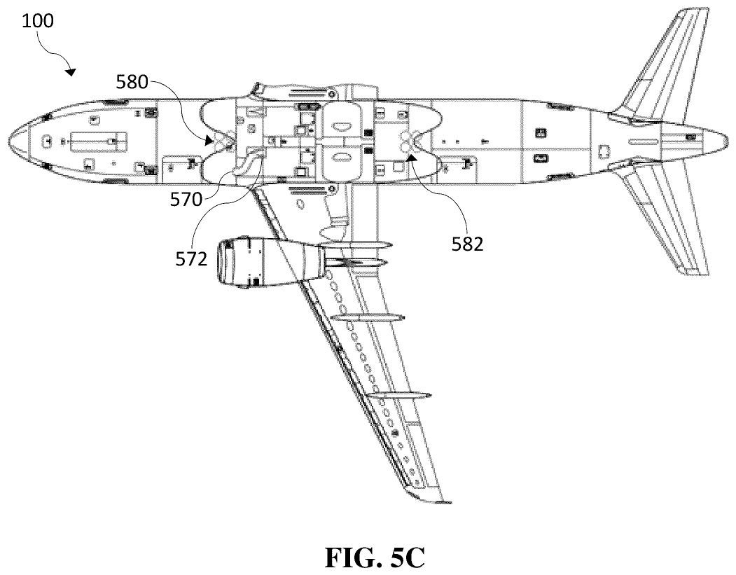

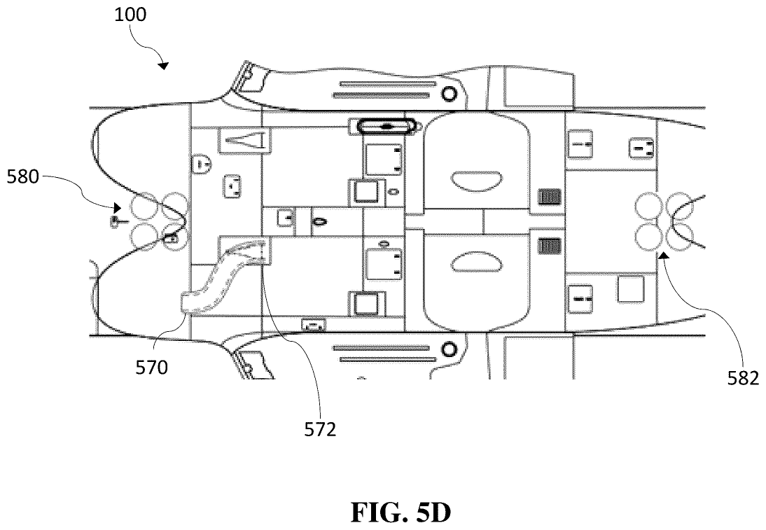

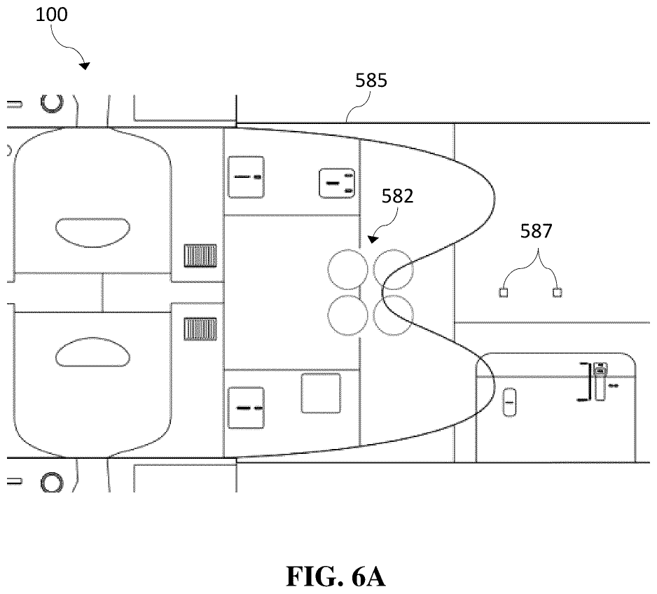

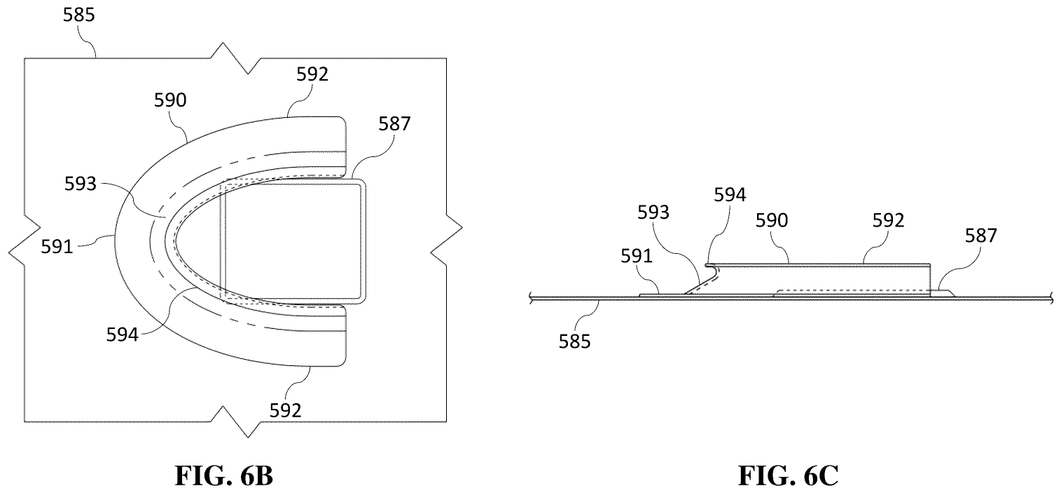

FIG. 1 is an illustration of a partial cutaway side view of an aircraft 100 housing an aerial firefighting delivery system 110 in accordance with certain embodiments of the present disclosure. Aerial firefighting delivery system 110 is configured to carry one or more firefighting agents for the purpose of dropping the firefighting agents on a fire. As shown, aircraft 100 includes a fuselage 120 defining an interior space within aircraft 100 that is bisected into a main deck 122 and a lower deck 124 via a fuselage floor structure 126. A pair of wings are coupled to fuselage 120, where a first wing 130 is disposed on a first side of fuselage 120 and a second wing (not depicted) is disposed on a second side of fuselage 120. A first storage tank 140 is positioned within main deck 122 and forward of the pair of wings while a second storage tank 150 is positioned within main deck 122 and aft of the pair of wings. A first discharge ducting 145 is positioned in lower deck 124 and fluidly connects first storage tank 140 to a first plurality of discharge outlets (see FIGS. 5C, 5D, and 6A) disposed in an underbelly 160 of fuselage 120. A second discharge ducting 155 is positioned in the lower deck 124 and fluidly connects second storage tank 150 to a second plurality of discharge outlets (see FIGS. 5C, 5D, and 6A) disposed in underbelly 160 of fuselage 120. The first and second plurality of discharge outlets are positioned at the underbelly 160 in order to maximize head pressure. In the embodiment depicted, first storage tank 140 comprises a capacity of 2000 gallons while second storage tank 150 comprises a capacity of 2400 gallons.

In embodiments, aerial firefighting delivery system 110 is configured to be retrofitted to aircraft 100, where aircraft 100 is, for example, an Airbus A319. In the case of aircraft 100 being an Airbus model aircraft, no modification of the Airbus flight control laws are made.

In certain embodiments, the weight of the tanks 140,150 and all structural adaptations are minimized and do not exceed 30% of firefighting agent total weight.

In embodiments, aerial firefighting delivery system 110 may provide a flow rate of at least 1125 US gallons per second (42601/sec). This flow rate may earn approval of the USFS for use of aerial firefighting delivery system 110 in the field.

In embodiments, a constant flow rate decrease may be greater than 20%.

It is noted that in scenarios where a full drop of firefighting agent is performed, a maximum of 1% of firefighting agent may remain in each of tanks 140, and 150.

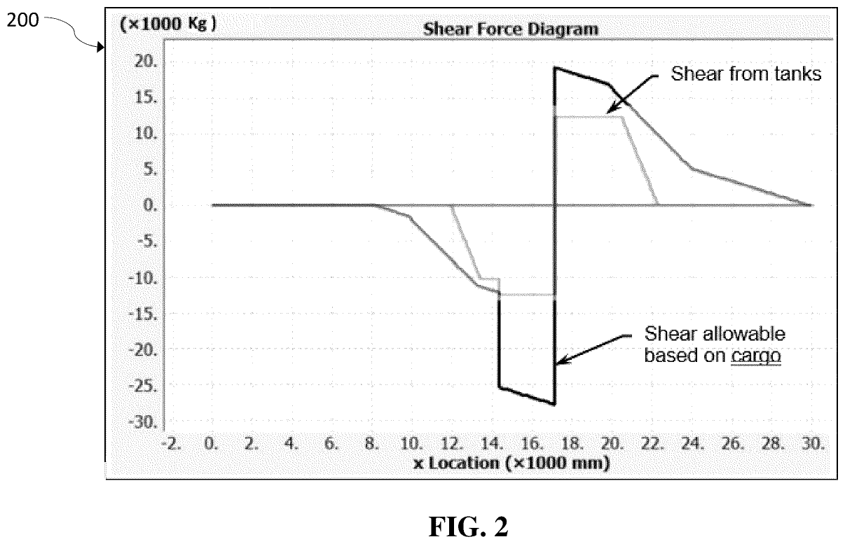

FIG. 2 is an illustration of a shear force diagram 200 comparing the shear force on a 1 g cargo load and a 1 g retardant tank load in accordance with certain embodiments of the present disclosure. As shown, an assessment on fuselage shell structure strength margins is carried out using shear force measurements, where the shear force measurements are considered to be an allowable limit based on the cargo (tanks).

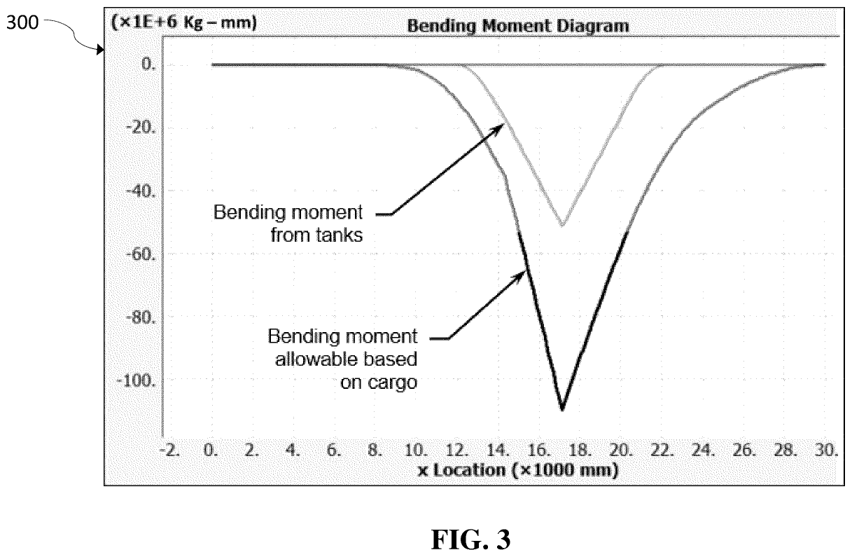

FIG. 3 is an illustration of a bending moment diagram comparing the bending moment of a 1 g cargo load and a 1 g retardant tank load in accordance with certain embodiments of the present disclosure. As shown, a further assessment on fuselage shell structure strength margins is carried out using bending moment measurements, where the bending moment measurements are considered to be an allowable limit based on the cargo (tanks).

Based on the diagrams presented in FIGS. 2 and 3, it can be seen that the overall fuselage structure embodies salient structural margins in both vertical shear and vertical bending for the disclosed tank configuration. It is noted that set parameters utilized in the aforementioned assessments in regard to FIGS. 2 and 3 include: an allowable main deck cargo load of 0.868 kg/mm, an allowable lower deck cargo load of 1.95 kg/mm, a volume of firefighting agent of 2250 gallons per tank (at 9 lbs/gallon), and tank weights of 25% of the firefighting agent weights.

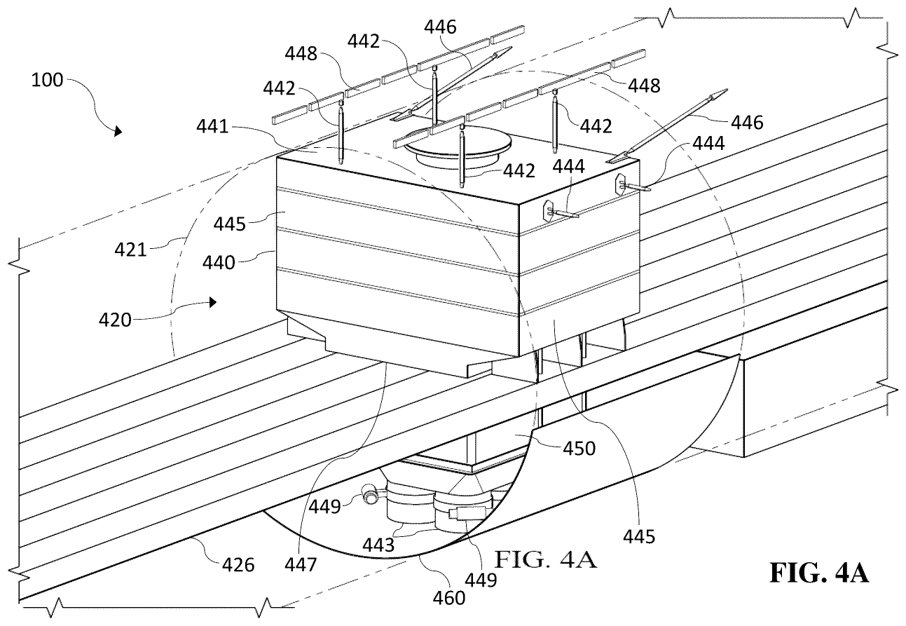

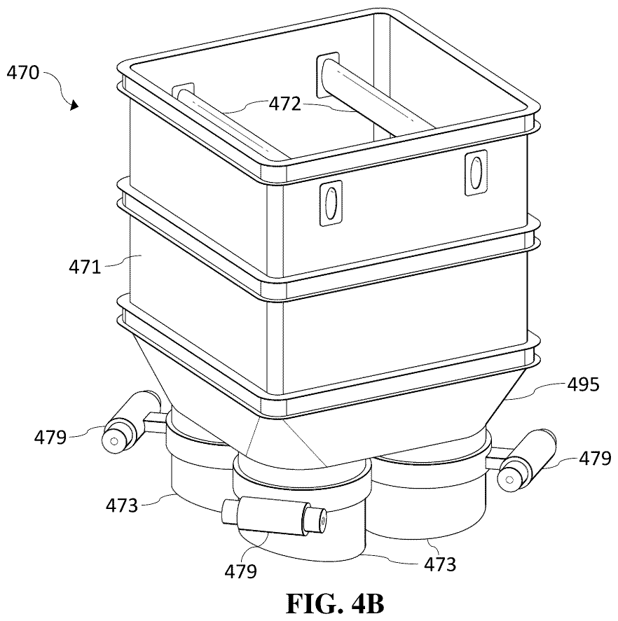

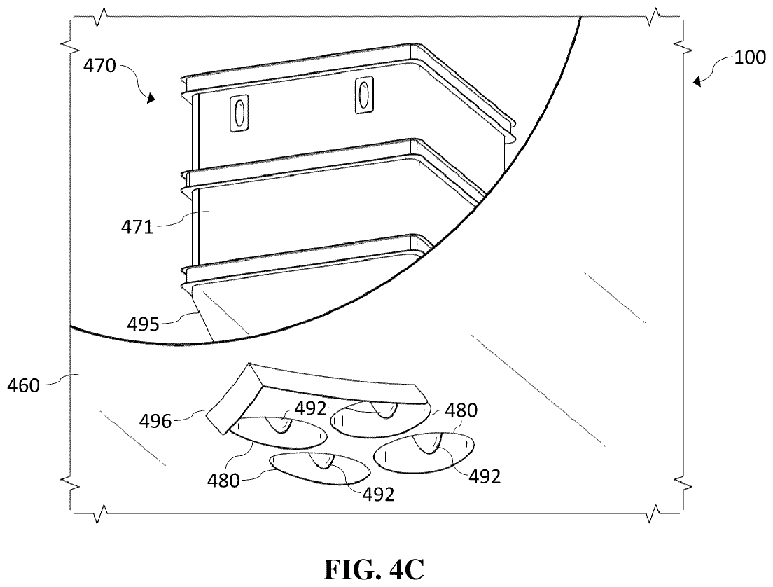

FIG. 4A is an illustration of a storage tank 440 installed in a fuselage 420 of an aircraft 100 in accordance with certain embodiments of the present disclosure. In order to effectively fit aerial firefighting delivery system 110 in aircraft 100, fuselage floor structure 426 may be modified to allow for storage tanks and associated discharge ducting 450 to be properly fitted and supported during all load cases. As depicted, tank loads of storage tank 440, in order to avoid overloading a floor structure 426 of fuselage 420, may be distributed to a shell 421 of fuselage 420 using one or more securement elements. Securement elements may include, but are not limited to: vertical support struts 442, horizontal support struts 444, tie rods 446, intercoastal support beams 448, and/or reinforcing doublers 449.

Vertical support struts 442 may be affixed either at a top end 441 or a bottom end 447 of storage tank 440. Vertical support struts 442 affixed to the top end 441 may be affixed to intercoastal support beams 448 in order to distribute point loads from vertical support struts 442 to shell 421. Vertical support struts 442 affixed to the bottom end 447 (not depicted) may be affixed to an underbelly 460 (or cargo floor) of shell 421 in order to distribute additional load from vertical support struts 442 to shell 421. Horizontal support struts 444 affixed to sides 445 of storage tank 440 may be affixed to sides of shell 421 to distribute side loads. In the case of a forward emergency landing, tie rods 446 may be utilized and are affixed to a rear of storage tank 440 and to a ceiling and/or floor structure 426 of shell 421 for vertical load distribution. The horizontal support struts 444 may also assist in the case of a forward emergency landing (up to 9 g). The reinforcing doublers 449 are configured to carry skin shell loads around cylinders 443 embodying the first and second plurality of discharge outlets 580,582 (see FIGS. 4C and 5C-5D).

FIG. 4B is an illustration of an alternative storage tank 470 in accordance with certain embodiments of the present disclosure. In this embodiment, a pair of pass-throughs 472 extend through tank body 471 along a plane axis extending from a nose to a tail of an aircraft (such as, for example, aircraft 100). Pass-throughs 472, as constructed, are configured to reduce lateral movement of tank body 471 which increases the stabilization of tank body 471. The pass-throughs 472 are also hollow, which may provide space for additional stabilizing materials to be run through tank body 471. Additionally, along the bottom of tank body 471, reinforcing doublers 479 are configured to carry skin shell loads around cylinders 473 defining the discharge outlets 480 (see FIG. 4C).

FIG. 4C is an illustration of a bottom perspective view of the alternative storage tank 470 installed in a fuselage 420 of an aircraft 100 in accordance with certain embodiments of the present disclosure. As shown, discharge outlets 480 are positioned in an underbelly 460 of aircraft 100 and are aligned with cylinders 473 of discharge ducting 495. When aircraft is prepared to drop firefighting agent on a target area, discharge valves 492 positioned within each cylinder 473 are opened so that firefighting agent stored in storage tank 470 may flow out of discharge outlets 480 and onto the target area. In certain embodiments, each of the discharge valves 492 may be butterfly valves. Additionally, a fairing 496 is positioned in front of discharge outlets 480 to divert firefighting agent dropped from additional discharge outlets 580 (see FIGS. 5C and 5D) that are positioned closer to the front of aircraft 100. When the firefighting agent is dropped from the additional discharge outlets 580 during a flight, fairing 496 diverts the flow of the firefighting agent around discharge outlets 480 in order to reduce interference to the stream of firefighting agent exiting discharge outlets 480.

It is noted that in certain embodiments, tanks 140,150,440,470 as constructed, are configured to avoid structural installations across the floor structure (such as, for example, “breathing” splices).

FIGS. 5A and 5B are illustrations of side views of an aircraft 100 including an offset inlet duct 570 in accordance with certain embodiments of the present disclosure. As shown, offset inlet duct 570 is affixed to a ram-air inlet 572 of aircraft 100 (positioned near the centerline of aircraft 100) and extends distal to the body of aircraft 100. Offset inlet duct 570 is positioned just forward of a left wing 530 of aircraft 100. As shown in FIGS. 5C and 5D, ram-air inlet 572 is at least partially positioned behind a first plurality of discharge outlets 580. The first plurality of discharge outlets 580 and a second plurality of discharge outlets 582 are positioned along a plane axis extending from a nose to a tail of aircraft 100, further where one or more firefighting agents disbursed from the first plurality of discharge outlets 580 and the second plurality of discharge outlets 582 define a flow path of the one or more firefighting agents aligned along the plane axis when the one or more firefighting agents are dropped during a flight of aircraft 100. In order to avoid the firefighting agent flow path, offset inlet duct 570 is offset to from ram-air inlet 572 so that ingestion of firefighting agent into ram-air inlet 572 is avoided. In the embodiment shown in FIGS. 5C and 5D, offset inlet duct 570 is offset to the right of ram-air inlet 572.

FIG. 6A is an illustration of a zoomed-in view of an underbelly 585 of an aircraft 100 including a pair of RADALT (radar altimeter) antennas 587 in accordance with certain embodiments of the present disclosure. As shown, two RADALT antennas 587 exist directly in the firefighting agent airflow zone behind outlet ducts 582. In order to protect the RADALT antennas 587 from exposure to the firefighting agent, as shown in FIG. 6B, a fairing 590 is positioned adjacent each of the RADALT antennas 587. Fairing 590 is arc-shaped/curved and includes a crown portion 591 and a pair of legs 592 that extend away from crown portion 591 in a curved fashion. Crown portion is positioned adjacent/in front of the portion of RADALT antenna 587 that is closest to a second plurality of discharge outlets 582 (see FIG. 6A) while legs 592 wrap around a majority of RADALT antenna 587.

As shown in FIG. 6C, fairing 590 is thicker than RADALT antenna 587 so that RADALT antenna 587 is protected from firefighting agents when aircraft 100 is performing a drop of firefighting agents during a flight. Fairing 590 further includes a slanted body 593 terminating at a drip edge 594. When firefighting agent is released and lands on fairing 590, the firefighting agent is collected at the drip edge 594 and, due to friction drag, the firefighting agent is dispersed down the legs 592 of fairing 590, thus keeping RADALT antenna 587 free of firefighting agent deposits/potential interference. By virtue of the configuration of fairing 590, RADALT antennas 587 can be safely protected at their natural position on the plane, avoiding expensive relocation costs (the aircraft's fly-by-wire control system would need to be reconfigured if relocation were to occur).

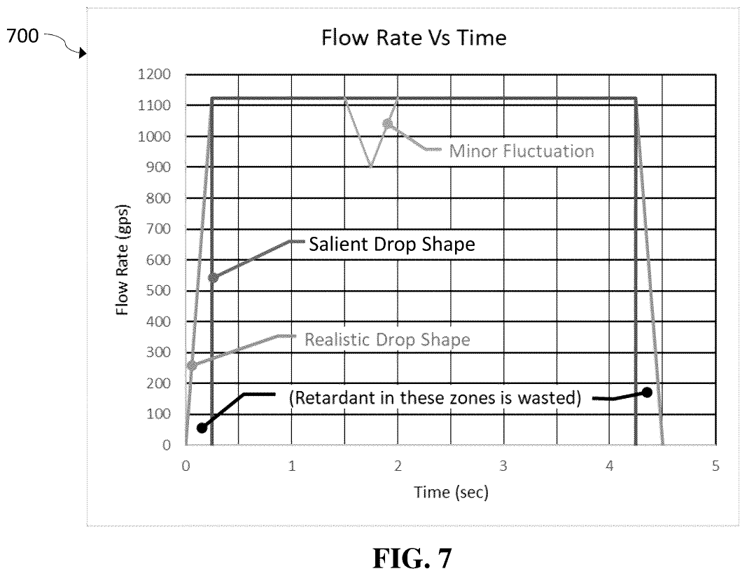

FIG. 7 is an illustration of a flow rate diagram 700 comparing flow rates of various drop scenarios in accordance with certain embodiments of the present disclosure. As shown in the diagram, a salient drop shape is presented where almost no time has passed and is coupled with a maximal increase in flow rate. A more realistic drop shape is presented just outside of the salient drop shapes. As further shown in diagram 700, a maximum flow rate of 1125 gallons per second is presented for the scenarios presented.

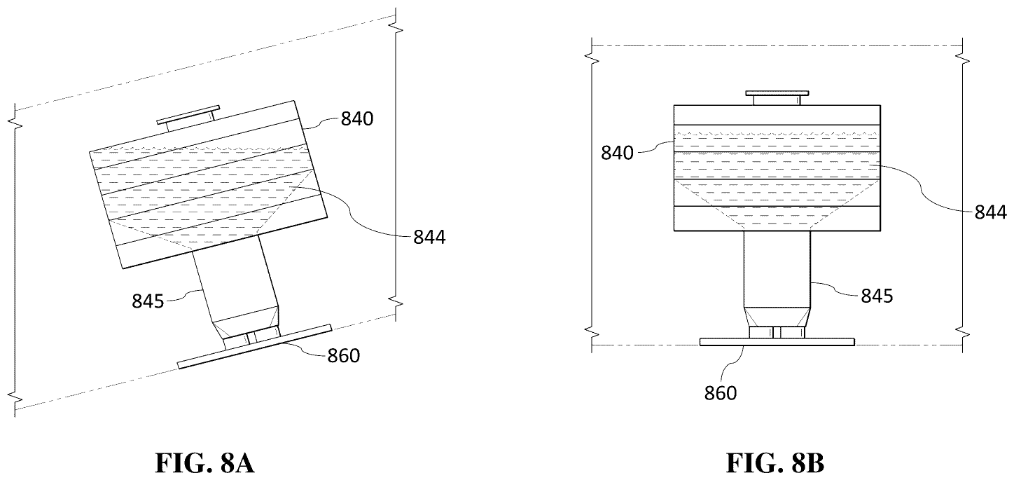

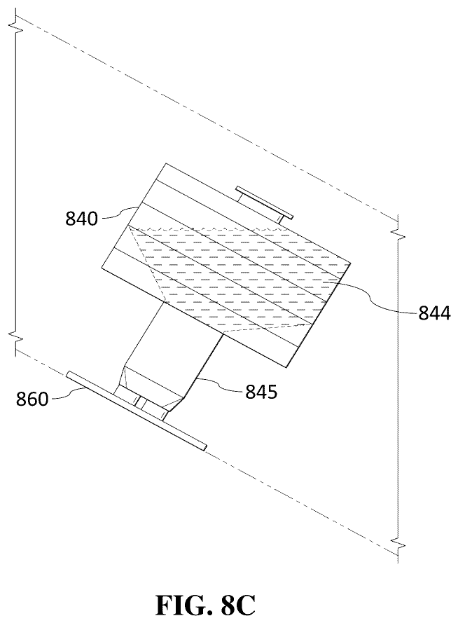

FIG. 8A is an illustration of a diagrammatic view of a storage tank 840 angled at a decline angle of 15 degrees in accordance with certain embodiments of the present disclosure. In this instance, aircraft 100 has been evaluated for weight and balance effects of storage tank 840 at maximum capacity and at lower capacities as well. As disclosed, aircraft 100/storage tank 840 has been tested at multiple attitudes. For example, storage tank 840 as shown in FIG. 8A is presented where aircraft 100 is positioned at a flying level of 15° nose down attitude. As another example, storage tank 840 as shown in FIG. 8B is presented where aircraft 100 is positioned at a level flying attitude. As an additional example, storage tank 840 as shown in FIG. 8C is presented where aircraft 100 is positioned at a flying level of 30° nose up attitude. In all three scenarios, aircraft 100 was able to remain within normal center of gravity ranges for all attitudes and tank quantities.

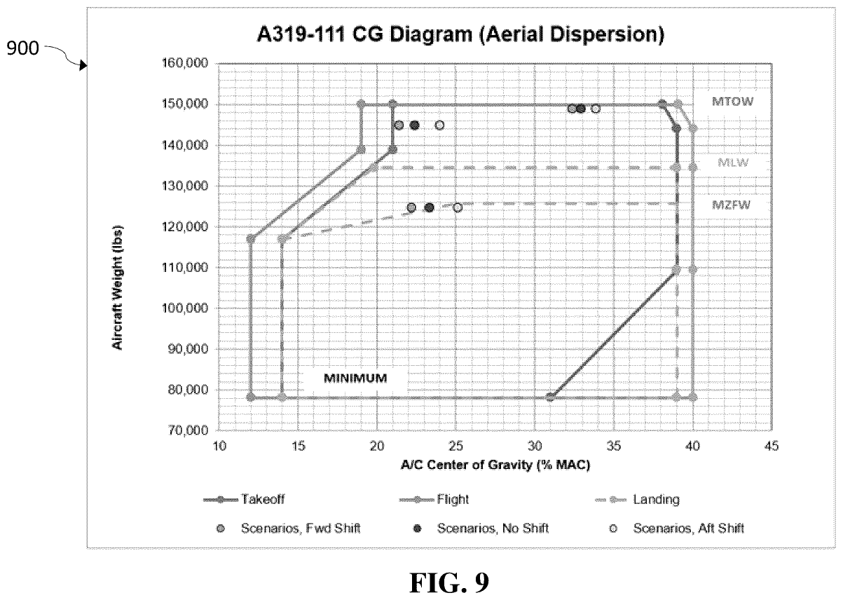

FIG. 9 is an illustration of a diagram 900 comparing an aircraft weight and the aircraft center of gravity for different flying stages of an exemplary aircraft (A319-111) in accordance with certain embodiments of the present disclosure. Maintaining a balanced center of gravity of an aircraft is imperative when performing a drop of firefighting agent over a target area. The weight of the firefighting agent can easily influence the center of gravity of an aircraft during a flight. In regard to an embodiment with an aircraft housing two tanks filled with firefighting agent, storage capacity, and flow rate should be carefully maintained so that a drop may be successfully carried out. For example, if one of the two tanks reduces its volume of firefighting agent spontaneously (due to a leak, for example) or too quickly in comparison to the other tank, the aircraft may become compromised due to a dangerous shift in the center of gravity from the unbalanced volume reduction. During a flight, the monitoring of firefighting agent released from the tanks should occur for the duration of the flight. Below, Table 1 presents exemplary data relative to three different flying scenarios:

TABLE 1
A/C Center of Gravity (% MAC), Aerial Dispersion

| | | | | Retardant | Retardant | Retardant |
|---|---|---|---|---|---|---|
| | Gallons | | | (No | (FWD | (AFT |
| Scenarios | Fuel | Retardant | Weight | Shift) | Shift) | Shift) |
| 1 | 0 | 4,400 | 124,682 | 23.33 | 22.19 | 25.15 |
| 2 | 3,000 | 4,400 | 144,711 | 22.40 | 21.41 | 23.96 |
| 6 | 6,303 | 2,400 | 148,764 | 32.92 | 32.37 | 33.86 |

In regard to flying Scenario 1, no fuel is used, 4,400 gallons of firefighting agent are carried, and the aircraft weight is 124,682 pounds. When no shift of firefighting agent occurs, the center of gravity (in % Mean Aerodynamic Chord (MAC)) is 23.33%. When a forward shift of firefighting agent occurs, the center of gravity (in % MAC) is 22.19%. When an aft shift of firefighting agent occurs, the center of gravity (in % MAC) is 25.15%.

In regard to flying Scenario 2, 3,000 gallons of fuel is used, 4,400 gallons of firefighting agent are carried, and the aircraft weight is 144,711 pounds. When no shift of firefighting agent occurs, the center of gravity (in % MAC) is 22.40%. When a forward shift of firefighting agent occurs, the center of gravity (in % MAC) is 21.41%. When an aft shift of firefighting agent occurs, the center of gravity (in % MAC) is 23.96%.

In regard to flying Scenario 6, 6,303 gallons of fuel is used, 2,400 gallons of firefighting agent are carried, and the aircraft weight is 148,764 pounds. When no shift of firefighting agent occurs, the center of gravity (in % MAC) is 32.92%. When a forward shift of firefighting agent occurs, the center of gravity (in % MAC) is 32.37%. When an aft shift of firefighting agent occurs, the center of gravity (in % MAC) is 33.86%.

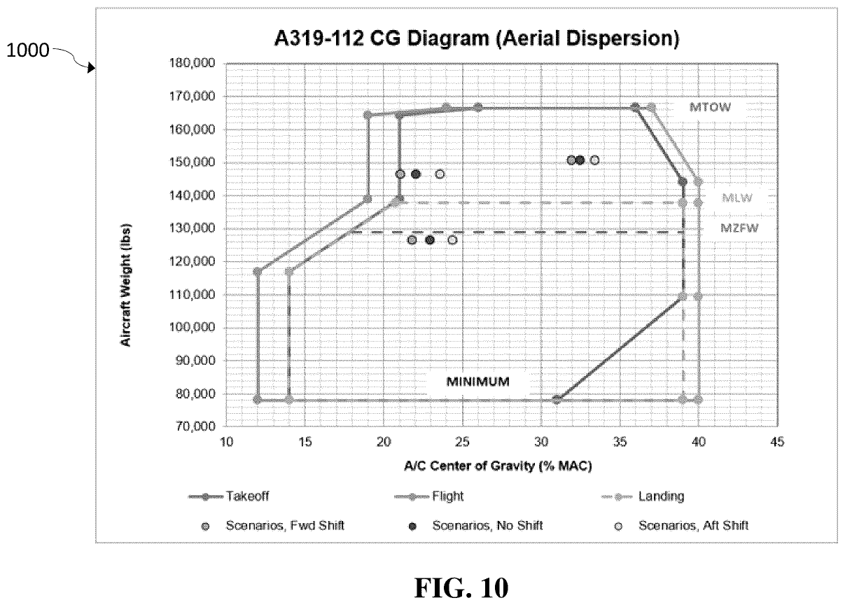

FIG. 10 is an illustration of a diagram 1000 comparing an aircraft weight and the aircraft center of gravity for different flying stages of an additional exemplary aircraft (A319-112) in accordance with certain embodiments of the present disclosure. Below, Table 2 presents exemplary data relative to three different flying scenarios:

TABLE 2
A/C Center of Gravity (% MAC), Aerial Dispersion

| | | | | Retardant | Retardant | Retardant |
|---|---|---|---|---|---|---|
| | Gallons | | | (No | (FWD | (AFT |
| Scenarios | Fuel | Retardant | Weight | Shift) | Shift) | Shift) |
| 1 | 0 | 4,400 | 126,409 | 22.93 | 21.80 | 24.36 |
| 2 | 3,000 | 4,400 | 146,438 | 22.06 | 21.08 | 23.60 |
| 6 | 6,303 | 2,400 | 150,491 | 32.47 | 31.93 | 33.40 |

In regard to flying Scenario 1, no fuel is used, 4,400 gallons of firefighting agent are carried, and the aircraft weight is 126,409 pounds. When no shift of firefighting agent occurs, the center of gravity (in % MAC) is 22.93%. When a forward shift of firefighting agent occurs, the center of gravity (in % MAC) is 21.80%. When an aft shift of firefighting agent occurs, the center of gravity (in % MAC) is 24.36%.

In regard to flying Scenario 2, 3,000 gallons of fuel is used, 4,400 gallons of firefighting agent are carried, and the aircraft weight is 146,438 pounds. When no shift of firefighting agent occurs, the center of gravity (in % MAC) is 22.06%. When a forward shift of firefighting agent occurs, the center of gravity (in % MAC) is 21.08%. When an aft shift of firefighting agent occurs, the center of gravity (in % MAC) is 23.60%.

In regard to flying Scenario 6, 6,303 gallons of fuel is used, 2,400 gallons of firefighting agent are carried, and the aircraft weight is 150,491 pounds. When no shift of firefighting agent occurs, the center of gravity (in % MAC) is 32.47%. When a forward shift of firefighting agent occurs, the center of gravity (in % MAC) is 31.93%. When an aft shift of firefighting agent occurs, the center of gravity (in % MAC) is 33.40%.

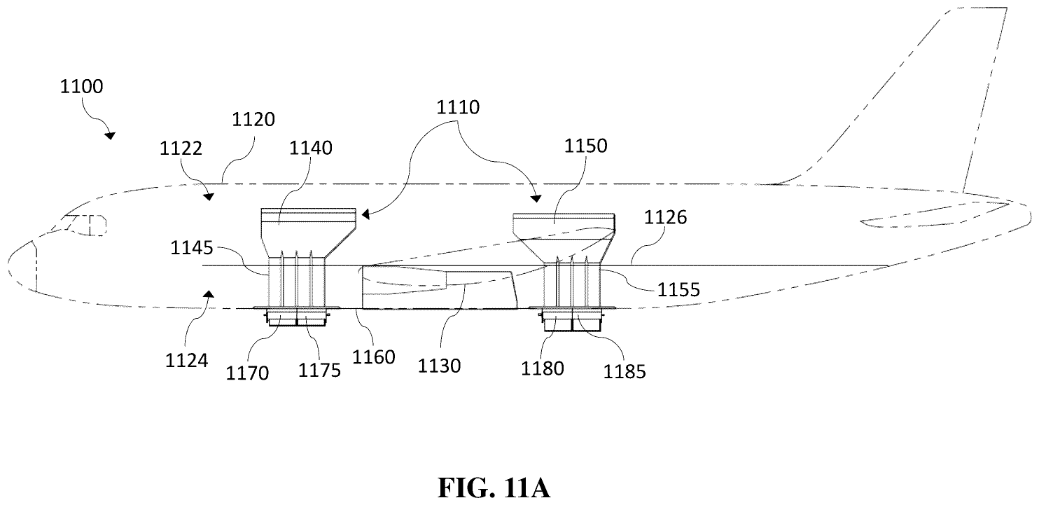

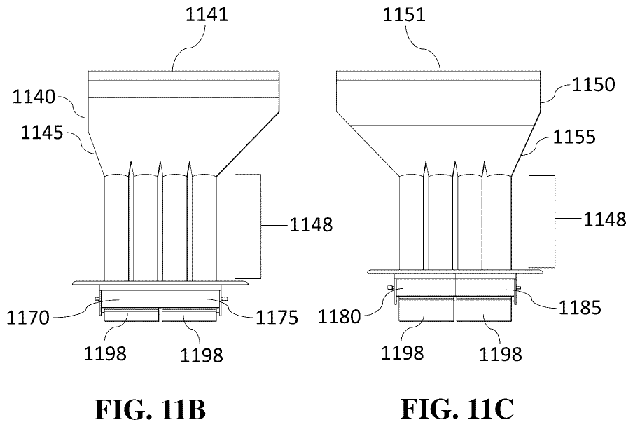

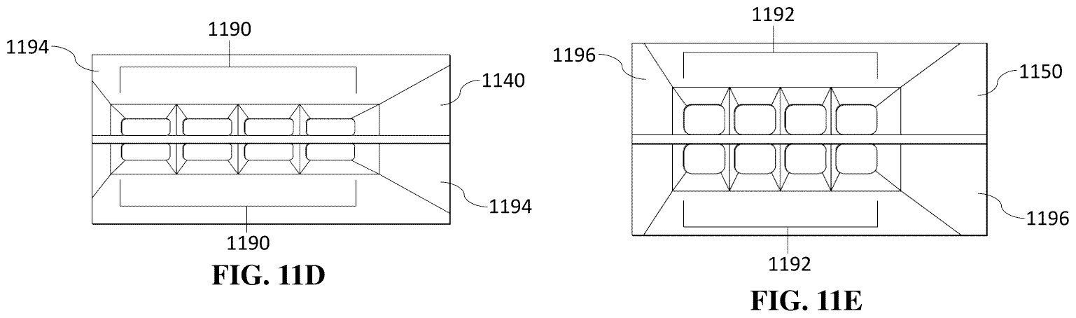

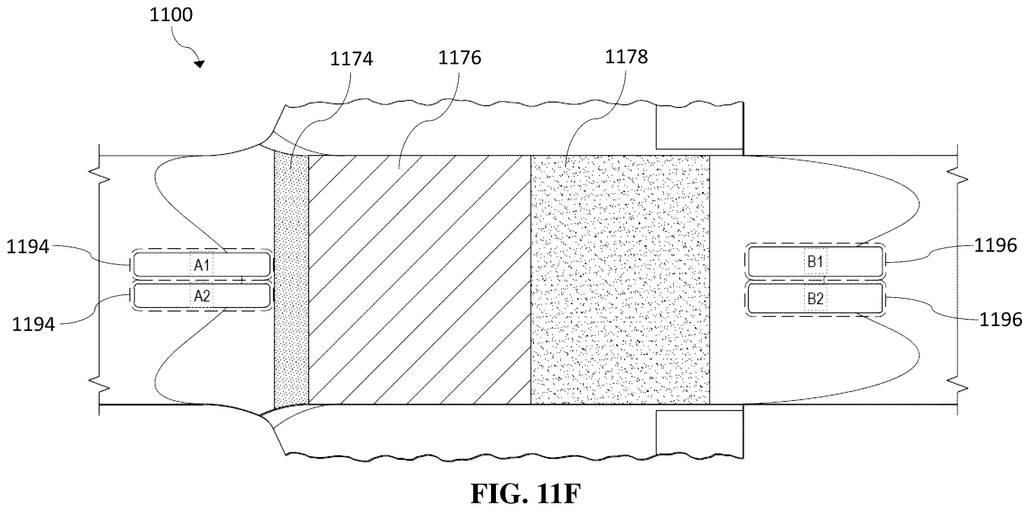

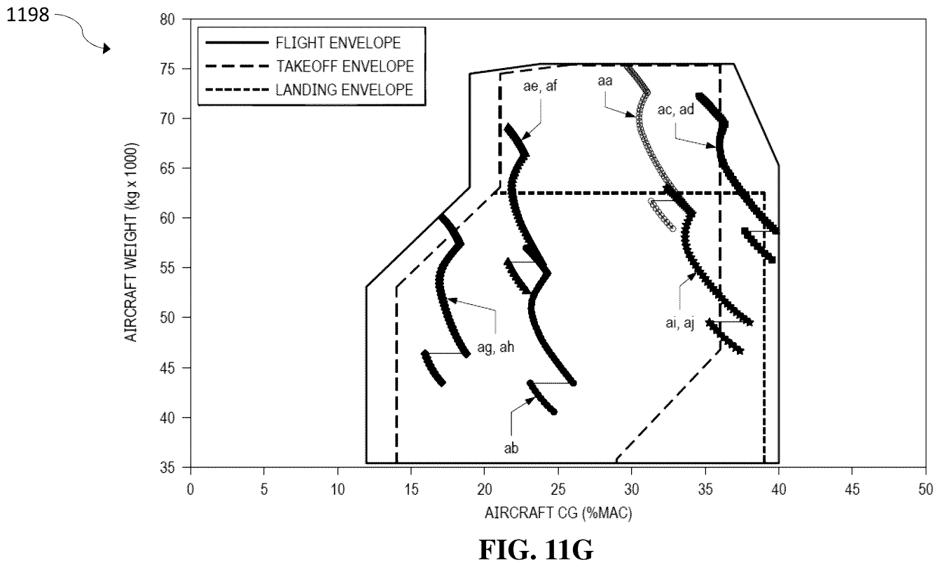

FIG. 11A is an illustration of a partial cutaway side view of an aircraft 1100 housing an alternative embodiment of an aerial firefighting delivery system 1110 in accordance with certain embodiments of the present disclosure. It is noted that aircraft 1100 may be structurally similar to aircraft 100 of FIG. 1 and may include one or more similar elements of aircraft 100 unless specified otherwise. As shown, aircraft 1100 includes a fuselage 1120 defining an interior space within aircraft 1100 that is bisected into a main deck 1122 and a lower deck 1124 via a fuselage floor structure 1126. A first storage tank 1140 is positioned within a main deck 1122 and forward of a pair of wings 1130 while a second storage tank 1150 is positioned within main deck 1122 and aft of the pair of wings 1130. At least a portion of a first discharge ducting 1145 is positioned in lower deck 1124 and fluidly connects first storage tank 1140 to a first pair of gate boxes 1170,1175 disposed adjacent an underbelly 1160 of fuselage 1120. At least a portion of a second discharge ducting 1155 is positioned in the lower deck 1124 and fluidly connects second storage tank 1150 to a second pair of gate boxes 1180,1185 disposed adjacent underbelly 1160 of fuselage 1120. The first pair of gate boxes 1170,1175 is positioned below/outside fuselage 1120 and fluidly connect first discharge ducting 1145 to a first plurality of discharge outlets 1190 (depicted in FIG. 11D). The second pair of gate boxes 1180,1185 is positioned below/outside fuselage 1120 and fluidly connect second discharge ducting 1155 to a second plurality of discharge outlets 1192 (depicted in FIG. 11E). It is noted that the first and second plurality of discharge outlets 1190,1192 are positioned at the underbelly 1160 in order to maximize head pressure.

FIGS. 11B and 11C are illustrations of the first and second storage tanks 1140,1150 of the aerial firefighting delivery system 1110 of FIG. 11A in accordance with certain embodiments of the present disclosure. The first and second storage tanks 1140,1150 in this embodiment utilizes gate boxes 1170,1175,1180,1185 to retain and provide a pathway for a firefighting agent. As shown, first and second storage tanks 1140,1150 each include respective top covers 1141,1151 so that first and second storage tanks 1140,1150 are sealed. As further shown, first storage tank 1140 comprises first discharge ducting 1145 terminating in four pairs of cylinders 1148 (only four cylinders are viewable from the angle shown). Second storage tank 1150 comprises second discharge ducting 1155 terminating in four pairs of cylinders 1148 (only four are also viewable from the angle shown). Each of first and second pairs of gate boxes 1170,1175,1180,1185 include a pair of gates 1198 (only one is viewable from the angle shown) that are mechanically affixed to the gate boxes 1170,1175,1180,1185. When actuated, each pair of gates 1198 may open to provide a clear path for a firefighting agent to pass through.

As shown in FIG. 11D, the first storage tank 1140/first discharge ducting 1145 is bisected into partitions 1194 so that firefighting agent is released out of four of the first plurality of discharge outlets 1190 on each side. As additionally shown in FIG. 11E, the second storage tank 1150/second discharge ducting 1155 is bisected into partitions 1196 so that a firefighting agent is released out of four of the second plurality of discharge outlets 1192 on each side. It is noted that in the embodiment depicted, first storage tank 1140 comprises a smaller capacity than second storage tank 1150. In one exemplary embodiment, first storage tank 1140 may comprise a capacity of 1465 gallons while second storage tank 1150 may comprise a capacity of 3035 gallons. In this exemplary embodiment, based on a total capacity of 4500 gallons, first storage tank 1140 comprises 32.5% of the total capacity while second storage tank 1150 comprises 67.5% of the total capacity.

FIG. 11F is an illustration of a zoomed-in partial bottom view of the aircraft 1100 of FIG. 11A in accordance with certain embodiments of the present disclosure. As shown, the first plurality of discharge outlets 1190 and the second plurality of discharge outlets 1192 (as presented in FIGS. 11D and 11E within partitions 1194,1196) are positioned along a plane axis extending from a nose to a tail of aircraft 1100. Partitions 1194 defining locations of the first plurality of discharge outlets 1190 are located forward of a mixer unit section 1174, which is forward of a central wing box (CWB) 1176 and a main landing gearbox 1178 (consecutively). Partitions 1196 defining locations of the second plurality of discharge outlets 1192 are located behind the main landing gearbox 1178 (in embodiments, the second plurality of discharge outlets 1192 may be positioned one inter-frame width away from main landing gearbox 1178).

FIG. 11G is an illustration of a diagram 1198 comparing an aircraft weight and an aircraft center of gravity (CG) in accordance with certain embodiments of the present disclosure. As shown, diagram 1198 presents multiple instances of first and second storage tanks 1140,1150 (labeled as “aa” through “aj”) being flown with different liquid/firefighting agent configurations. The measurements of an aircraft weight and aircraft center of gravity (measured in % MAC, or “Mean Aerodynamic Chord”) for each case is compared against flight, takeoff, and landing envelopes (which present boundaries for each segment of flight). In these specific instances, first and second storage tanks 1140,1150 are separated into the following partitions: A1 (first storage tank 1140), A2 (first storage tank 1140), B1 (second storage tank 1150), and B2 (second storage tank 1150). For each case, firefighting agent is added to varying partitions of first and second storage tanks 1140,1150, which is presented below in Table 3:

TABLE 3
Tank Levels for Each CG Case

| | Forward Tank Level | | Aft Tank Level | |
|---|---|---|---|---|
| CG case | A1 | A2 | B1 | B2 |
| aa | FULL | FULL | FULL | FULL |
| ab | EMPTY | EMPTY | EMPTY | EMPTY |
| ac | EMPTY | FULL | FULL | FULL |
| ad | FULL | EMPTY | FULL | FULL |
| ae | FULL | FULL | EMPTY | FULL |
| af | FULL | FULL | FULL | EMPTY |
| ag | FULL | EMPTY | EMPTY | EMPTY |
| ah | EMPTY | FULL | EMPTY | EMPTY |
| ai | EMPTY | EMPTY | FULL | EMPTY |
| aj | EMPTY | EMPTY | EMPTY | FULL |

As an example, Table 3 above presents storage tanks case “ac”, where partition A1 is empty and partition A2, B1, and B2 are full. For the purposes of this disclosure, the term “partitioned area” may refer to an entire segmented volume defined along the entire height of first and second storage tanks 1140,1150/first and second discharge ductings 1145,1155. In this instance, A1 does not hold firefighting agent, A2 holds 732.5 gallons (half of the total presented in the description of FIG. 11D), B1 holds 1517.5 gallons (half of the total presented in the description of FIG. 11D), and B2 holds 1517.5 gallons (half of the total presented in the description of FIG. 11D). As presented in diagram 1198, the points representing case “ac” are at least partially positioned in the takeoff and landing envelopes, while the entirety of the points are positioned in the flight envelope. As a whole, the data points for all cases show that the storage tank configurations presented in FIGS. 11A, 11B, and 11C meet W002 CoG requirements.

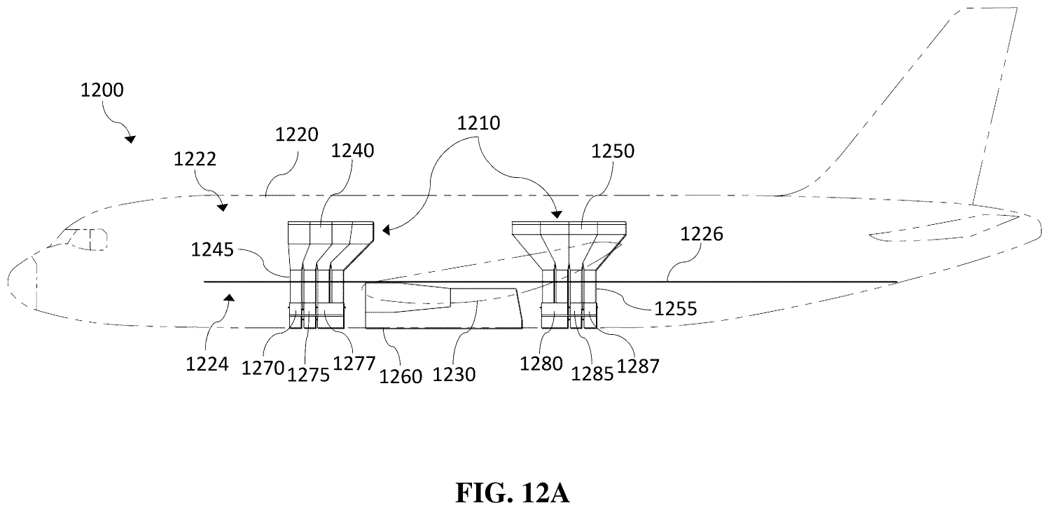

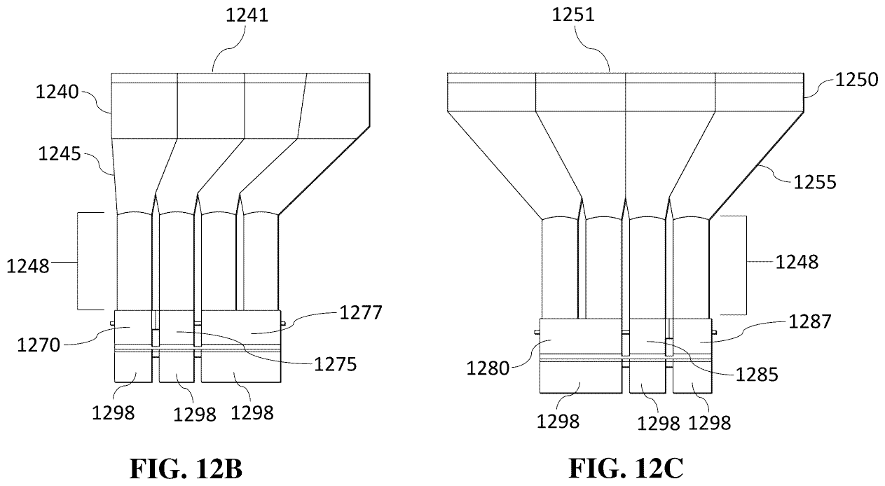

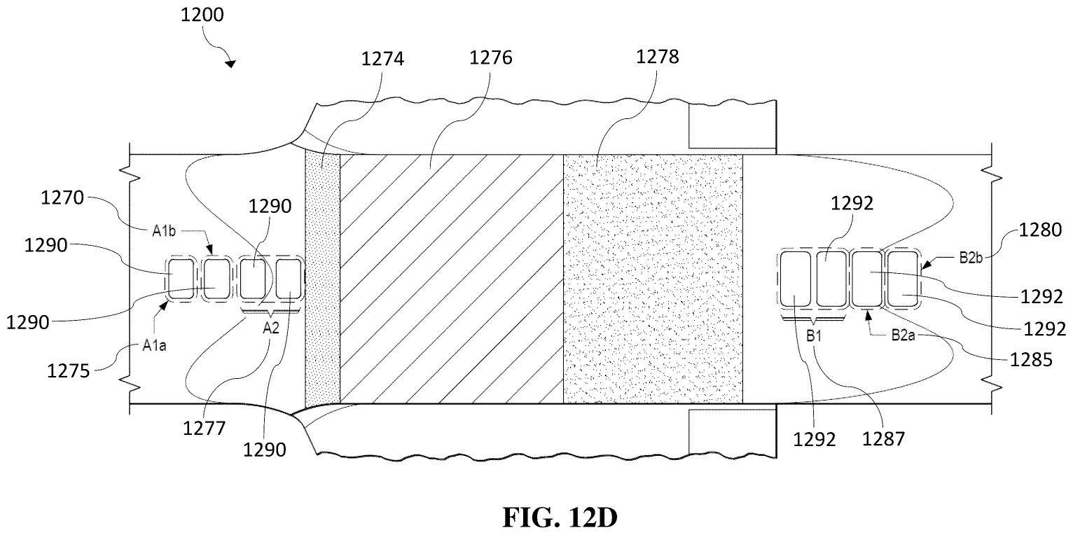

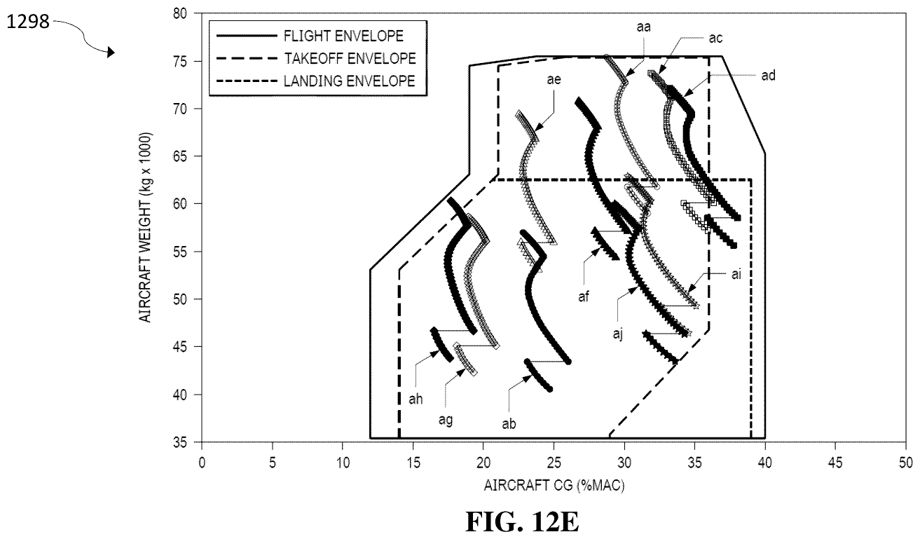

FIG. 12A is an illustration of a partial cutaway side view of an aircraft 1200 housing an alternative embodiment of an aerial firefighting delivery system 1210 in accordance with certain embodiments of the present disclosure. It is noted that aircraft 1200 may be structurally similar to aircraft 100 of FIG. 1 and may include one or more similar elements of aircraft 100 unless specified otherwise. As shown, aircraft 1200 includes a fuselage 1220 defining an interior space within aircraft 1200 that is bisected into a main deck 1222 and a lower deck 1224 via a fuselage floor structure 1226. A first storage tank 1240 is positioned within a main deck 1222 and forward of a pair of wings 1260 while a second storage tank 1250 is positioned within main deck 1222 and aft of the pair of wings 1260. At least a portion of a first discharge ducting 1245 is positioned in lower deck 1224 and fluidly connects first storage tank 1240 to a first set of gate boxes 1270,1275,1277 (three gate boxes) disposed in an underbelly 1260 of fuselage 1220. At least a portion of a second discharge ducting 1255 is positioned in the lower deck 1224 and fluidly connects second storage tank 1250 to a second set of gate boxes 1280,1285,1287 disposed in underbelly 1260 of fuselage 1220. The first set of gate boxes 1270,1275,1277 is positioned within fuselage 1220 and fluidly connect first discharge ducting 1245 to a first plurality of discharge outlets 1290 (depicted in FIG. 12D). A second set of gate boxes 1280,1285,1287 is positioned within fuselage 1220 and fluidly connect second discharge ducting 1255 to a second plurality of discharge outlets 1292 (depicted in FIG. 12D). It is noted that the first and second plurality of discharge outlets 1290,1292 are positioned at the underbelly 1260 in order to maximize head pressure.

FIGS. 12B and 12C are illustrations of the first and second storage tanks 1240,1250 of the aerial firefighting delivery system 1210 of FIG. 12A in accordance with certain embodiments of the present disclosure. The first and second storage tanks 1240,1250 in this embodiment utilizes gate boxes 1270,1275,1277,1280,1285,1287 to retain and provide a pathway for a firefighting agent. As shown, first and second storage tanks 1240,1250 each include respective top covers 1241,1251 so that first and second storage tanks 1240,1250 are sealed. As further shown, first storage tank 1240 comprises first discharge ducting 1245 terminating in four pairs of cylinders 1248 (only four cylinders are viewable from the angle shown). Second storage tank 1250 comprises second discharge ducting 1255 terminating in four pairs of cylinders 1248 (only four are also viewable from the angle shown). It is noted that gate boxes 1277 and 1280 are configured to be twice the size of gate boxes 1270,1275, 1285, and 1287 and are each further configured to receive firefighting agent from two cylinders 1248, as opposed to one (applies to gate boxes 1270,1275, 1285, and 1287). Each of first and second sets of gate boxes 1270,1275,1277,1280,1285,1287 include pairs of gates 1298 (only one angle is viewable from the angle shown) that are mechanically affixed to gate boxes 1270,1275,1277,1280,1285,1287. When actuated, each pair of gates 1298 may open to provide a clear path for a firefighting agent to pass through. It is noted that in the embodiments depicted, first storage tank 1240 comprises a smaller capacity than second storage tank 1250. In one exemplary embodiment, first storage tank 1240 may comprise a capacity of 1620 gallons while second storage tank 1150 may comprise a capacity of 2880 gallons. In this embodiment, based on a total capacity of 4500 gallons, first storage tank 1240 comprises 36% of the total capacity while second storage tank 1250 comprises 64% of the total capacity. In another exemplary embodiment, first storage tank 1240 may comprise a capacity of 1615 gallons while second storage tank 1150 may comprise a capacity of 2885 gallons.

FIG. 12D is an illustration of a zoomed-in partial bottom view of the aircraft 1200 of FIG. 12A in accordance with certain embodiments of the present disclosure. As shown, the first plurality of discharge outlets 1290 and the second plurality of discharge outlets 1292 (associated with/within partitions 1270,1275,1277,1280,1285,1287) are positioned along a plane axis extending from a nose to a tail of aircraft 1200. Partitions 1270,1275,1277 defining locations of the first plurality of discharge outlets 1290 are located forward of a mixer unit section 1274, which is forward of a central wing box (CWB) 1276 and a main landing gearbox 1278 (consecutively). Partitions 1280,1285,1287 defining locations of the second plurality of discharge outlets 1292 are located behind the main landing gearbox 1278 (in embodiments, the second plurality of discharge outlets 1192 may be positioned one inter-frame width away from main landing gearbox 1278). Specifically, the first plurality of discharge outlets 1290 are defined within three partitions 1270,1275,1277, where partitions A1a and A1b are each associated with a respective one of the first plurality of discharge outlets 1290 and are separately partitioned from A2 (which is associated with two of the first plurality of discharge outlets 1290). Additionally, the second plurality of discharge outlets 1292 are defined within three partitions 1280,1285,1287, where partitions B2a and B2b are each associated with a respective one of the second plurality of discharge outlets 1292 and are separately partitioned from B1 (which is associated with two of the second plurality of discharge outlets 1292). It is further noted that partitions 1280,1285,1287 are larger in width than partitions 1270,1275,1277.

FIG. 12E is an illustration of a diagram 1298 comparing an aircraft weight and an aircraft center of gravity (CG) in accordance with certain embodiments of the present disclosure. As shown, diagram 1298 presents multiple cases of first and second storage tanks 1240,1250 (labeled as “aa” through “aj”) being flown with different liquid/firefighting agent configurations. The measurements of an aircraft weight and aircraft center of gravity (measured in % MAC, or “Mean Aerodynamic Chord”) for each case is compared against flight, takeoff, and landing envelopes (which present boundaries for each segment of flight). In these specific instances, first and second storage tanks 1240,1250 are separated into the following partitions: A1a (first storage tank 1240), A1b (first storage tank 1240), A2 (first storage tank 1240), B1 (second storage tank 1250), B2a (second storage tank 1250), and B2b (second storage tank 1250). For each case, firefighting agent is added to varying partitions of first and second storage tanks 1240,1250, which is presented below in Table 4:

TABLE 4
Tank Levels for Each CG Case

| CG | Forward Tank Level | | | Aft Tank Level | | |
|---|---|---|---|---|---|---|
| Case | A1a | A1b | A2 | B1 | B2a | B2b |
| aa | FULL | FULL | FULL | FULL | FULL | FULL |
| ab | EMPTY | EMPTY | EMPTY | EMPTY | EMPTY | EMPTY |
| ac | EMPTY | FULL | FULL | FULL | FULL | FULL |
| ad | FULL | FULL | EMPTY | FULL | FULL | FULL |
| ae | FULL | FULL | FULL | EMPTY | FULL | FULL |
| af | FULL | FULL | FULL | FULL | FULL | EMPTY |
| ag | FULL | EMPTY | EMPTY | EMPTY | EMPTY | EMPTY |
| ah | EMPTY | EMPTY | FULL | EMPTY | EMPTY | EMPTY |
| ai | EMPTY | EMPTY | EMPTY | FULL | EMPTY | EMPTY |
| aj | EMPTY | EMPTY | EMPTY | EMPTY | EMPTY | FULL |

As an example, Table 4 above presents storage tanks case “ae”, where partition B1 is empty and partitions A1a, A1b, A2, B2a, and B2b are full. For the purposes of this disclosure, the term “partitions” may refer to an entire segmented volume defined along the entire height of first and second storage tanks 1240,1250/first and second discharge ductings 1245,1255. In this instance, B1 does not hold firefighting agent, A1a holds 405 gallons (one fourth of the total presented in the descriptions of FIGS. 12B and 12C), A1b holds 405 gallons (one fourth of the total presented in the descriptions of FIGS. 12B and 12C), A2 holds 810 gallons (half of the total presented in the descriptions of FIGS. 12B and 12C), B2a holds 720 gallons (one fourth of the total presented in the descriptions of FIGS. 12B and 12C), and B2b holds 720 gallons (one fourth of the total presented in the descriptions of FIGS. 12B and 12C). As presented in diagram 1298, the points representing case “ae” are at least partially positioned in the landing envelope, while the entirety of the points are positioned in the flight and takeoff envelopes. As a whole, the data points for all cases conclude that the storage tank configurations presented in FIGS. 12A, 12B, and 12C meet W002 CoG requirements.

In an additional embodiment in which each of the partitions of first and second storage tanks 1240,1250 include firefighting agent, A1a may hold 408 gallons, A1b may hold 417 gallons, A2 may hold 799 gallons, B1 may hold 1442 gallons, B2a may hold 712 gallons, and B2b may hold 731 gallons.

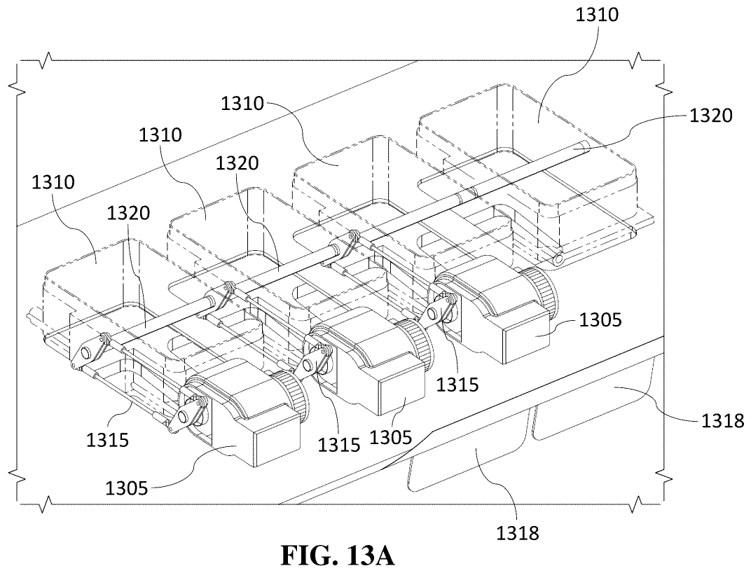

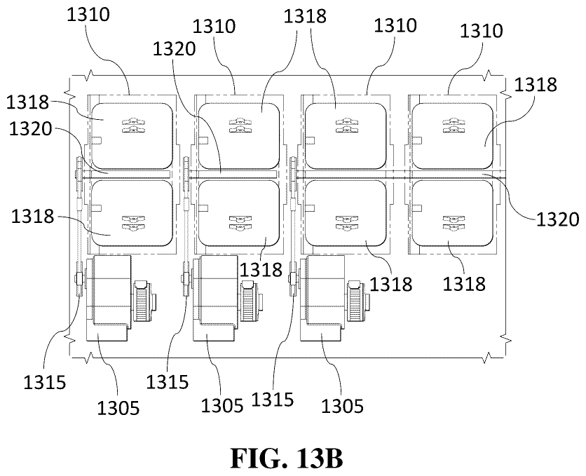

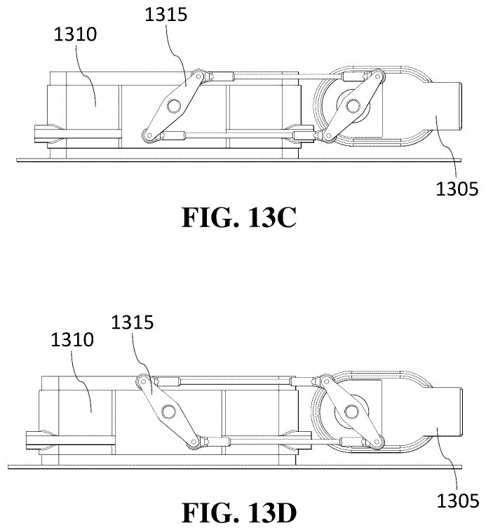

FIG. 13A is an illustration of a plurality of engines 1305 affixed to multiple gate boxes 1310 in accordance with certain embodiments of the present disclosure. As shown, each of four forward storage tank gate boxes 1310 are mechanically affixed to one or more engines 1305 of the plurality of engines 1305, where engines 1305 are positioned parallel to gate boxes 1310. In this embodiment, engines 1305 are positioned laterally in relation to the gate boxes 1310/the box shafts around which gate boxes 1310 are positioned. As further shown in FIG. 13B, the two left-most engines 1305 are each mechanically affixed to a single gate box 1310, while the right-most engine is mechanically affixed to two gate boxes 1310. In additional embodiments, the right-most engine may be mechanically affixed to a gate box 1310 that is positionable around the two right-most discharge outlets 1390 of the first plurality of discharge outlets 1390 of the forward storage tank gate boxes 1310.

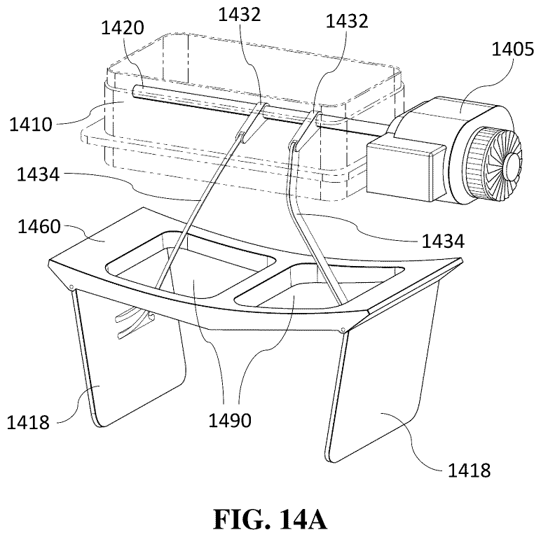

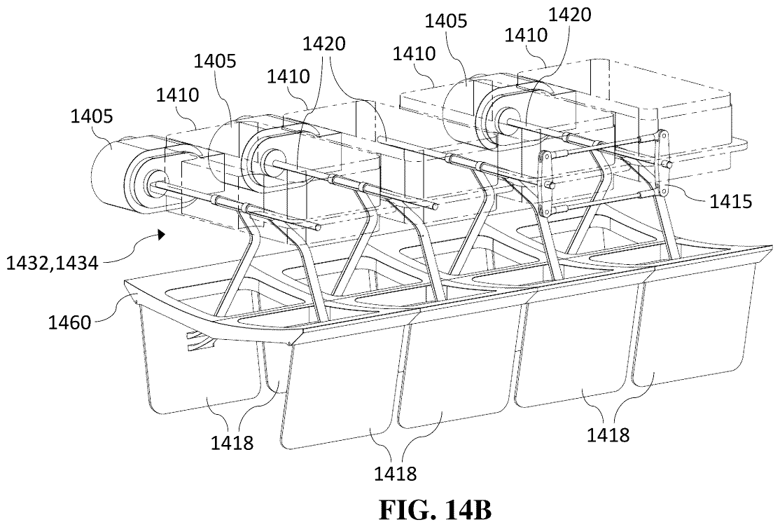

FIGS. 13C and 13D are illustrations of a single engine 1305 engaging a single gate box 1310 of FIG. 13A in accordance with certain embodiments of the present disclosure. As shown, engine 1305 is mechanically affixed to gate box 1310 via a transmission 1315. When actuated, transmission 1315 utilizes rotational energy produced by engine 1305 to rotate shaft 1320 (see FIG. 13B), producing additional rotational energy that may be transferred to an element (such as for example, an embodiment of an upper arm section 1432 affixed to a lower arm section 1434 via a radial spherical plain bearing as depicted similarly in FIG. 14A) to actuate and rotate gates 1318 to an open position. In reference to FIGS. 13A and 13B, the transmission 1315 of the right-most engine 1305 is affixed to a shaft 1320 that spans the width of the two right-most gate boxes 1310, allowing a single motor 1305 to open two pairs of gates 1318 (as opposed to one). In additional embodiments, a single gate 1318 may utilize a single motor 1305, a single transmission 1315, and a single shaft 1320 (using the rotational energy from the motor 1305 as described previously) in order to actuate and rotate the single gate 1318 to an open position. This embodiment, when applied to the setup disclosed in FIG. 13B, may utilize six engines 1305, six transmissions 1315, and six shafts 1320 to actuate and rotate the eight gates 1318 to an open position.

FIG. 14A is an illustration of a single engine 1405 engaging a single gate box 1410 in accordance with certain embodiments of the present disclosure. As shown, engine 1405 is mechanically affixed to a shaft 1420 and engine 1405 is positioned perpendicular to gate box 1410 (opposed to parallel, which is presented in FIGS. 13A-13D). A pair of arms 1430 are rotatably affixed to shaft 1420 via upper arm sections 1432 and are configured to rotate with shaft 1420. Each of upper arm sections 1432 are affixed to respective lower arm sections 1434 via a radial spherical plain bearing, allowing lower arm sections 1434 to move radially and inferiorly in relation to upper arm sections 1432. Lower arm sections 1434 are positioned through discharge outlets 1490 that are integrated within underbelly 1460 of an aircraft. The bottom ends of lower arm sections 1434 are affixed to gates 1410, which are configured to shift from a closed position to an open position and allow open passage of a firefighting agent through discharge outlets 1490 when shaft 1420 is rotated.

FIG. 14B is an illustration of multiple engines 1405 engaging multiple gate boxes 1410 of FIG. 14A in accordance with certain embodiments of the present disclosure. As shown, single engines 1405 and gate boxes 1410 are positionable over each pair of discharge outlets 1490 disposed in underbelly 1460. As shown similarly in FIGS. 13A and 13B, transmission 1415 of the right-most engine 1405 is affixed to two shafts 1320 (that extend along the length of gate boxes 1410 and are adjacent to one another), allowing a single motor 1405 to open two pairs of gates 1418 (as opposed to one).

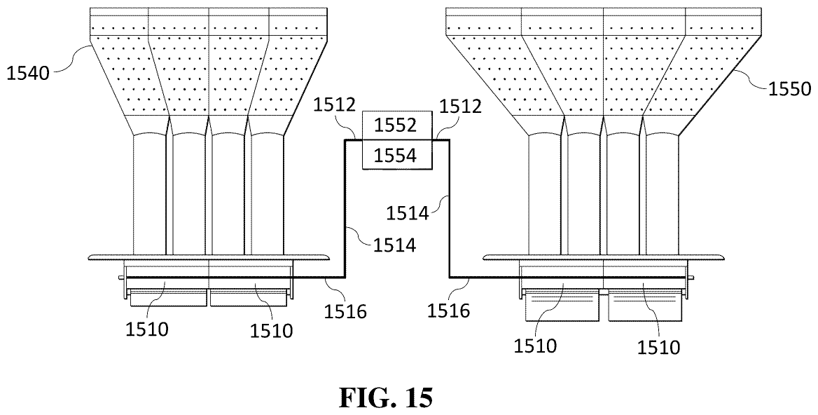

FIG. 15 is an illustration of a diagrammatic configuration of mechanically linked storage tanks 1540,1550 in accordance with certain embodiments of the present disclosure. As shown, storage tank 1540 is mechanically linked to engine 1552, while storage tank 1550 is mechanically linked to engine 1554. Each of the first shafts 1512 are rotationally affixed to respective engines 1552,1554. Second shafts 1514 are rotationally affixed to respective first shafts 1512 and third shafts, where third shafts are mechanically affixed to box gates 1510 in a configuration similar or substantially similar to the setup presented in FIGS. 14A and 14B that utilizes upper arm sections 1432 and lower arm sections 1434 connected via a radial spherical plain bearing. For the purposes of this embodiment, it is understood that one of the two engines 1552,1554 is mechanically affixed to a first shaft 1512, a second shaft 1514, a third shaft 1516, and one or more gate boxes 1510 that are positioned on a left-most side of an aircraft, while the other of the two engines is mechanically affixed to a first shaft 1512, a second shaft 1514, a third shaft 1516, and one or more gate boxes 1510 that are positioned on a right-most side of an aircraft. It is further noted that this embodiment includes gate boxes 1518 are positioned parallel along the length of the plane as opposed to perpendicular, which may be opposite other embodiments presented herein (in other embodiments, the gate boxes are oriented perpendicular to the length of an aircraft).

When engines 1552,1554 are actuated, the first shafts 1512 transfer the rotational energy to the second shafts 1514, which transfer the rotational energy to the third shafts 1516, allowing the upper arm sections 1432 and lower arm sections 1434 to open gates 1510. By way of this embodiment, multiple advantages may be realized. First, the mechanical linkage between components allows the system to avoid an asymmetrical release (which could cause a catastrophic failure and potentially causing the aircraft to crash). This configuration additionally: 1) avoids the need for storage tanks 1540,1550 to need partitions, 2) provides additional freedom of storage tank placement, and reduces certification and development time. In additional embodiments, engines 1552,1554 and shafts 1512,1514,1516 may employ either of: electrical components or hydraulic components within the interconnected system presented in FIG. 15.

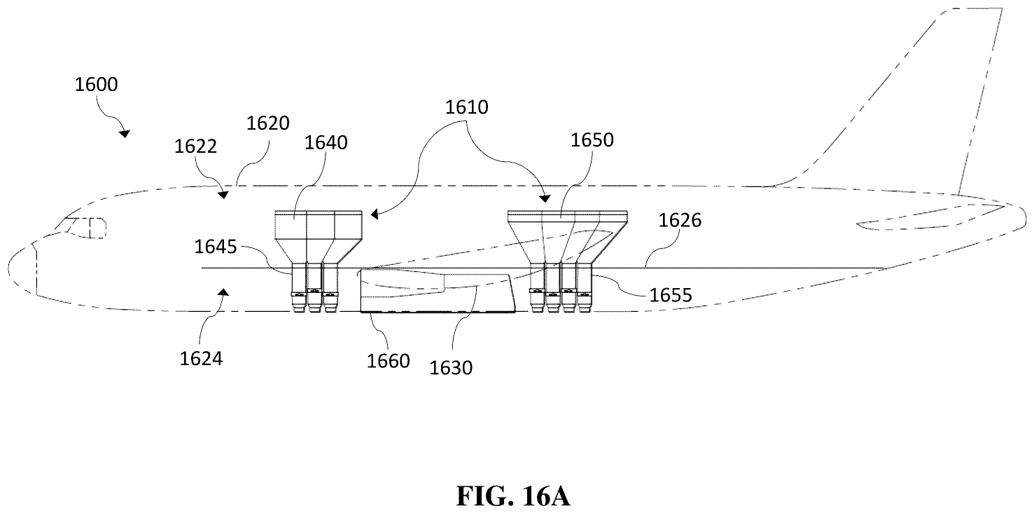

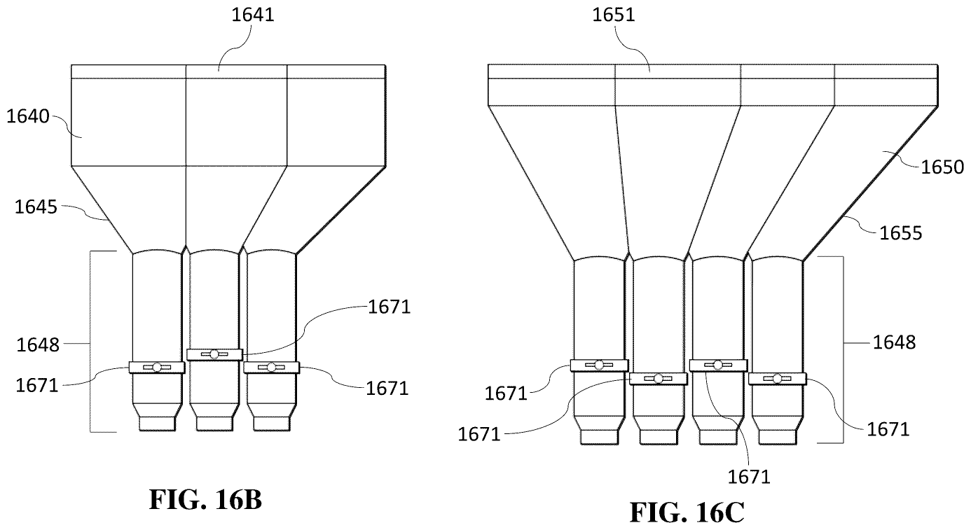

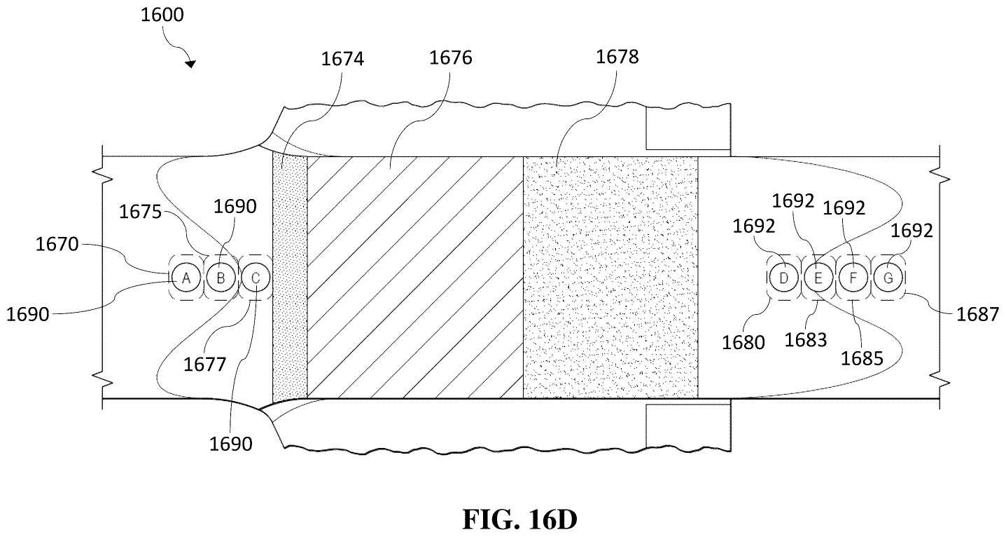

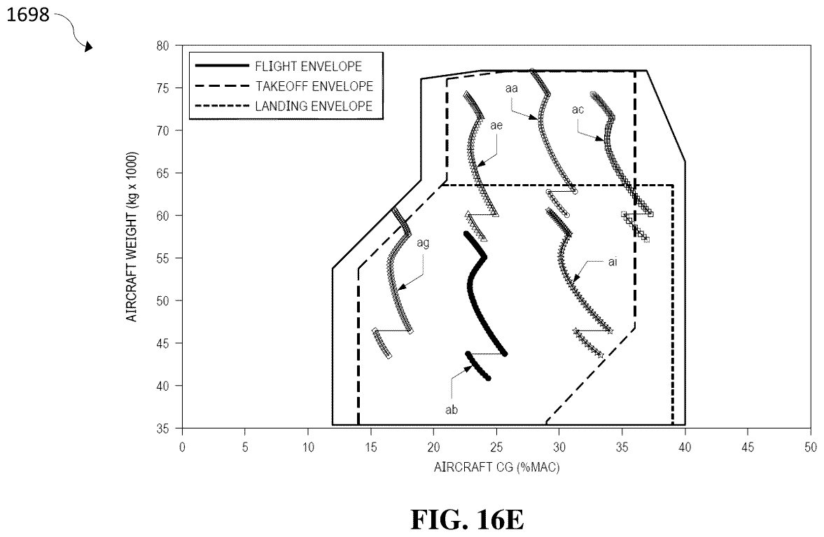

FIG. 16A is an illustration of a partial cutaway side view of an aircraft 1600 housing an alternative embodiment of an aerial firefighting delivery system 1610 in accordance with certain embodiments of the present disclosure. It is noted that aircraft 1600 may be structurally similar to aircraft 100 of FIG. 1 and may include one or more similar elements of aircraft 100 unless specified otherwise. As shown, aircraft 1600 includes a fuselage 1620 defining an interior space within aircraft 1600 that is bisected into a main deck 1622 and a lower deck 1624 via a fuselage floor structure 1626. A first storage tank 1640 is positioned within a main deck 1622 and forward of a pair of wings while a second storage tank 1650 is positioned within main deck 1622 and aft of the pair of wings. At least a portion of a first discharge ducting 1645 is positioned in lower deck 1624 and includes three pairs of cylinders 1648 (only three cylinders are viewable from the angle shown) terminating in a first plurality of discharge outlets 1690. At least a portion of a second discharge ducting 1655 is positioned in lower deck 1624 and includes four pairs of cylinders 1648 (only four cylinders are viewable from the angle shown) terminating in a second plurality of discharge outlets 1690. Each of the cylinders 1648 comprise a valve 1671 that is configured to control the flow rate of/provide an open pathway for a firefighting agent. It is noted that the first and second plurality of discharge outlets 1690,1692 are positioned at the underbelly 1660 in order to maximize head pressure.

FIGS. 16B and 16C are illustrations of the first and second storage tanks 1640,1650 of the aerial firefighting delivery system 1610 of FIG. 16A in accordance with certain embodiments of the present disclosure. The first and second storage tanks 1640,1650 in this embodiment utilizes valves 1671 to retain and provide a pathway for a firefighting agent. As shown, first and second storage tanks 1640,1650 each include respective top covers 1641,1651 so that first and second storage tanks 1640,1650 are sealed. As further shown, first storage tank 1640 comprises first discharge ducting 1645 terminating in three pairs of cylinders 1648 (only three cylinders are viewable from the angle shown). Second storage tank 1250 comprises second discharge ducting 1255 terminating in four pairs of cylinders 1248 (only four are also viewable from the angle shown). When actuated, each valve 1698 may open to provide a clear path for a firefighting agent to pass through. It is noted that in the embodiments depicted, first storage tank 1640 comprises a smaller capacity than second storage tank 1650. More specifically, first storage tank 1640 comprises a capacity of 1930 gallons while second storage tank 1650 comprises a capacity of 2570 gallons. Based on a total capacity of 4500 gallons, first storage tank 1640 comprises 43% of the total capacity while second storage tank 1650 comprises 57% of the total capacity.

FIG. 16D is an illustration of a zoomed-in partial bottom view of the aircraft 1600 of FIG. 16A in accordance with certain embodiments of the present disclosure. As shown, the first plurality of discharge outlets 1690 and the second plurality of discharge outlets 1692 (associated with/within partitions 1670,1675,1677,1680,1683,1685,1687) are positioned along a plane axis extending from a nose to a tail of aircraft 1600. Partitions 1670,1675,1677 defining locations of the first plurality of discharge outlets 1690 are located forward of a mixer unit section 1674, which is forward of a central wing box (CWB) 1676 and a main landing gearbox 1678 (consecutively). Partitions 1680,1683,1685,1687 defining locations of the second plurality of discharge outlets 1692 are located behind the main landing gearbox 1678 (in embodiments, the second plurality of discharge outlets 1692 may be positioned two inter-frame widths away from main landing gearbox 1678). Specifically, the first plurality of discharge outlets 1690 are defined within three partitions 1670,1675,1677, where partitions A, B, and C are each associated with a respective one of the first plurality of discharge outlets 1690. Additionally, the second plurality of discharge outlets 1692 are defined within four partitions 1680,1683,1685,1687, where partitions D, E, F, and G are each associated with a respective one of the second plurality of discharge outlets 1692.

FIG. 16E is an illustration of a diagram 1698 comparing an aircraft weight and an aircraft center of gravity (CG) in accordance with certain embodiments of the present disclosure. As shown, diagram 1698 presents multiple cases of first and second storage tanks 1640,1650 (labeled as “aa”, “ab”, “ac”, “ae”, “ag”, and “ai”) being flown with different liquid/firefighting agent configurations. The measurements of an aircraft weight and aircraft center of gravity (measured in % MAC, or “Mean Aerodynamic Chord”) for each case is compared against flight, takeoff, and landing envelopes (which present boundaries for each segment of flight). In these specific instances, first and second storage tanks 1640,1650 are separated into the following partitions: A (first storage tank 1640), B (first storage tank 1640), C (first storage tank 1640), D (second storage tank 1650), E (second storage tank 1650), F (second storage tank 1650), and G (second storage tank 1650). For each case, firefighting agent is added to varying partitions of first and second storage tanks 1640,1650, which is presented below in Table 4:

TABLE 5
Tank Levels for Each CG Case

| CG | Forward Tank Level | | | Aft Tank Level | | | |
|---|---|---|---|---|---|---|---|
| Case | A | B | C | D | F | F | G |
| aa | FULL | FULL | FULL | FULL | FULL | FULL | FULL |
| ab | EMPTY | EMPTY | EMPTY | EMPTY | EMPTY | EMPTY | EMPTY |
| ac | EMPTY | FULL | FULL | FULL | FULL | FULL | FULL |
| ae | FULL | FULL | FULL | FULL | FULL | FULL | EMPTY |
| ag | FULL | EMPTY | EMPTY | EMPTY | EMPTY | EMPTY | EMPTY |
| ai | EMPTY | EMPTY | EMPTY | EMPTY | EMPTY | EMPTY | FULL |

As an example, Table 5 above presents storage tanks case “ag”, where partition A is full and partitions B, C, D, E, F, and G are empty. For the purposes of this disclosure, the term “partitions” may refer to an entire segmented volume defined along the entire height of first and second storage tanks 1640,1650/first and second discharge ductings 1645,1655. As presented in diagram 1698, the points representing case “ag” are at least partially positioned in the landing and takeoff envelopes, while the entirety of the points are positioned in the flight envelope. As a whole, the data points for all cases conclude that the storage tank configurations presented in FIGS. 16A, 16B, and 16C meet W002 CoG requirements.

In an additional embodiment in which each of the partitions of first and second storage tanks 1640,1650 include firefighting agent, A may hold 690 gallons, B may hold 630 gallons, C may hold 610 gallons, D may hold 643 gallons, E may hold 673 gallons, F may hold 599 gallons, and G may hold 655 gallons.

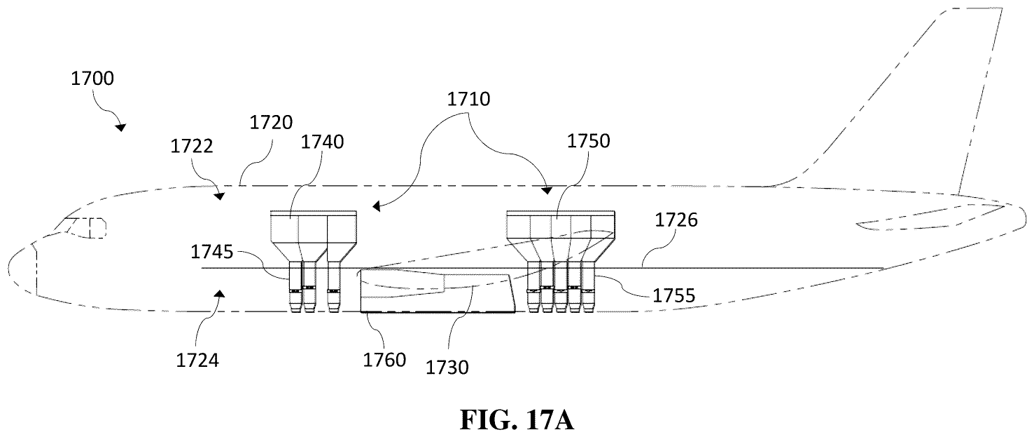

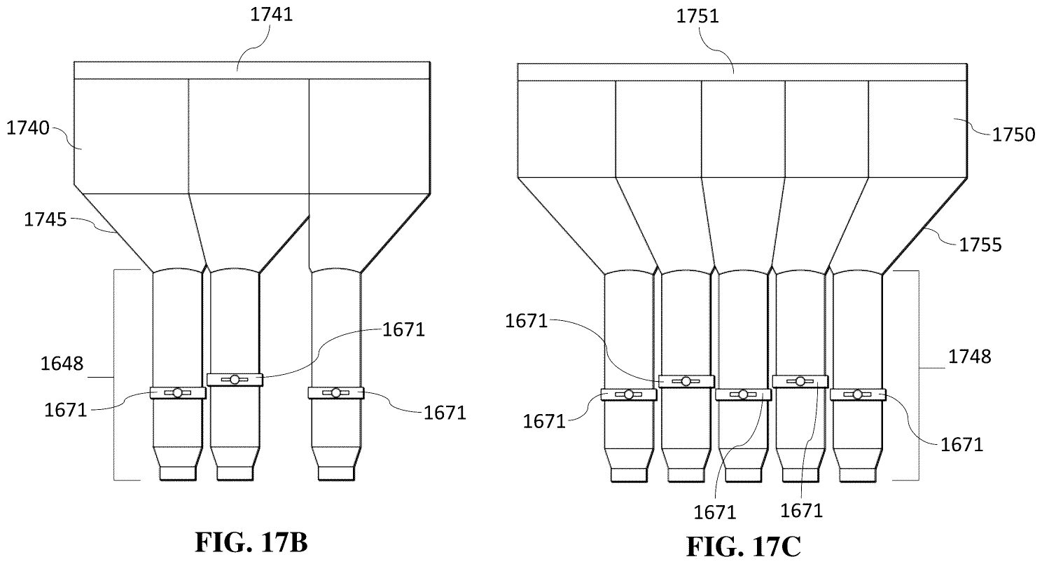

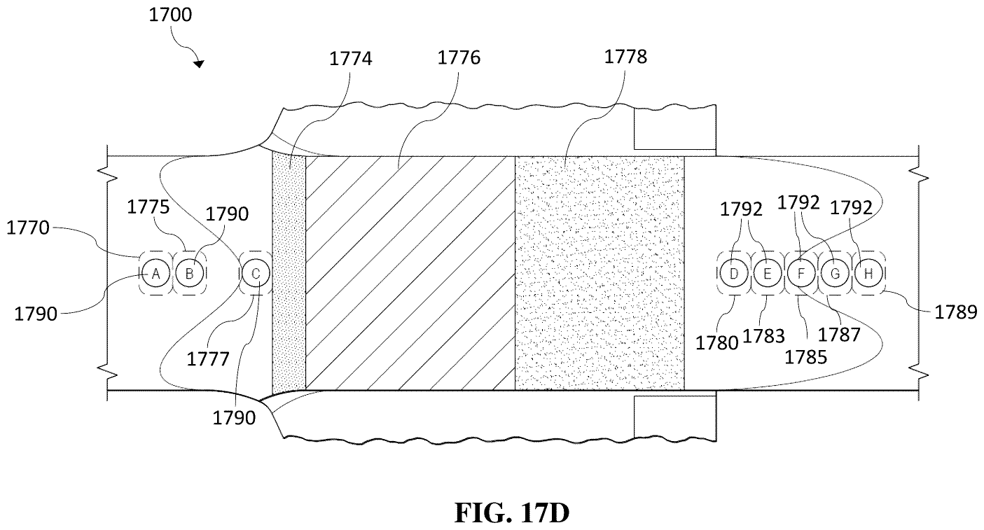

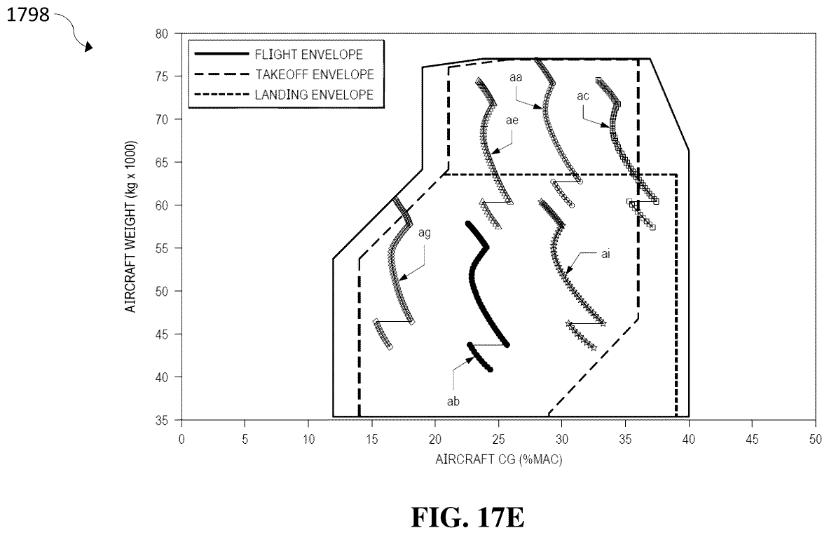

FIG. 17A is an illustration of a partial cutaway side view of an aircraft 1700 housing an alternative embodiment of an aerial firefighting delivery system 1710 in accordance with certain embodiments of the present disclosure. It is noted that aircraft 1700 may be structurally similar to aircraft 100 of FIG. 1 and may include one or more similar elements of aircraft 100 unless specified otherwise. As shown, aircraft 1700 includes a fuselage 1720 defining an interior space within aircraft 1700 that is bisected into a main deck 1722 and a lower deck 1724 via a fuselage floor structure 1726. A first storage tank 1740 is positioned within a main deck 1722 and forward of a pair of wings while a second storage tank 1750 is positioned within main deck 1722 and aft of the pair of wings. At least a portion of a first discharge ducting 1745 is positioned in lower deck 1724 and includes three pairs of cylinders 1748 (only three cylinders are viewable from the angle shown) terminating in a first plurality of discharge outlets 1790. At least a portion of a second discharge ducting 1755 is positioned in lower deck 1724 and includes five pairs of cylinders 1748 (only five cylinders are viewable from the angle shown) terminating in a second plurality of discharge outlets 1790. Each of the cylinders 1748 comprise a valve 1771 that is configured to control the flow rate of/provide an open pathway for a firefighting agent. It is noted that the first and second plurality of discharge outlets 1790,1792 are positioned at the underbelly 1760 in order to maximize head pressure.

FIGS. 17B and 17C are illustrations of the first and second storage tanks 1740,1750 of the aerial firefighting delivery system 1710 of FIG. 17A in accordance with certain embodiments of the present disclosure. The first and second storage tanks 1740,1750 in this embodiment utilizes valves 1771 to retain and provide a pathway for a firefighting agent. As shown, first and second storage tanks 1740,1750 each include respective top covers 1741,1751 so that first and second storage tanks 1740,1750 are sealed. As further shown, first storage tank 1740 comprises first discharge ducting 1745 terminating in three pairs of cylinders 1748 (only three cylinders are viewable from the angle shown). Second storage tank 1750 comprises second discharge ducting 1755 terminating in five pairs of cylinders 1748 (only five are also viewable from the angle shown). When actuated, each valve 1798 may open to provide a clear path for a firefighting agent to pass through. It is noted that in the embodiments depicted, first storage tank 1740 comprises a smaller capacity than second storage tank 1750. More specifically, first storage tank 1740 comprises a capacity of 1688 gallons while second storage tank 1750 comprises a capacity of 2812 gallons. Based on a total capacity of 4500 gallons, first storage tank 1740 comprises 37.5% of the total capacity while second storage tank 1750 comprises 62.5% of the total capacity.

FIG. 17D is an illustration of a zoomed-in partial bottom view of the aircraft 1700 of FIG. 17A in accordance with certain embodiments of the present disclosure. As shown, the first plurality of discharge outlets 1790 and the second plurality of discharge outlets 1792 (associated with/within partitions 1770,1775,1777,1780,1783,1785,1787,1789) are positioned along a plane axis extending from a nose to a tail of aircraft 1700. Partitions 1770,1775,1777 defining locations of the first plurality of discharge outlets 1790 are located forward of a mixer unit section 1774, which is forward of a central wing box (CWB) 1776 and a main landing gearbox 1778 (consecutively). Partitions 1780,1783,1785,1787,1789 defining locations of the second plurality of discharge outlets 1792 are located behind the main landing gearbox 1778 (in embodiments, the second plurality of discharge outlets 1792 may be positioned one inter-frame width away from main landing gearbox 1778). Specifically, the first plurality of discharge outlets 1790 are defined within three partitions 1770,1775,1777, where partitions A, B, and C are each associated with a respective one of the first plurality of discharge outlets 1790. Additionally, the second plurality of discharge outlets 1792 are defined within five partitions 1780,1783,1785,1787,1789, where partitions D, E, F, G, and H are each associated with a respective one of the second plurality of discharge outlets 1792. In embodiments, discharge outlets 1790 defined within partitions 1775 and 1777 may be spaced one inter-frame width from one another.

FIG. 17E is an illustration of a diagram 1798 comparing an aircraft weight and an aircraft center of gravity (CG) in accordance with certain embodiments of the present disclosure. As shown, diagram 1798 presents multiple cases of first and second storage tanks 1740,1750 (labeled as “aa”, “ab”, “ac”, “ae”, “ag”, and “ai”) being flown with different liquid/firefighting agent configurations. The measurements of an aircraft weight and aircraft center of gravity (measured in % MAC, or “Mean Aerodynamic Chord”) for each case is compared against flight, takeoff, and landing envelopes (which present boundaries for each segment of flight). In these specific instances, first and second storage tanks 1740,1750 are separated into the following partitions: A (first storage tank 1740), B (first storage tank 1740), C (first storage tank 1740), D (second storage tank 1750), E (second storage tank 1750), F (second storage tank 1750), G (second storage tank 1750), and H (second storage tank 1750). For each case, firefighting agent is added to varying partitions of first and second storage tanks 1740,1750, which is presented below in Table 6:

TABLE 6
Tank Levels for Each CG Case

| CG | Forward Tank Level | | | Aft Tank Level | | | | |
|---|---|---|---|---|---|---|---|---|
| Case | A | B | C | D | E | F | G | H |
| aa | FULL | FULL | FULL | FULL | FULL | FULL | FULL | FULL |
| ab | EMPTY | EMPTY | EMPTY | EMPTY | EMPTY | EMPTY | EMPTY | EMPTY |
| ac | EMPTY | FULL | FULL | FULL | FULL | FULL | FULL | FULL |
| ae | FULL | FULL | FULL | FULL | FULL | FULL | FULL | EMPTY |
| ag | FULL | EMPTY | EMPTY | EMPTY | EMPTY | EMPTY | EMPTY | EMPTY |
| ai | EMPTY | EMPTY | EMPTY | EMPTY | EMPTY | EMPTY | EMPTY | FULL |

As an example, Table 6 above presents storage tanks case “ai”, where partition H is full and partitions A, B, C, D, E, and F are empty. For the purposes of this disclosure, the term “partitions” may refer to an entire segmented volume defined along the entire height of first and second storage tanks 1740,1750/first and second discharge ductings 1745,1755. As presented in diagram 1798, the points representing case “ai” are all positioned within the flight, takeoff, and landing envelopes. As a whole, the data points for all cases conclude that the storage tank configurations presented in FIGS. 17A, 17B, and 17C meet W002 CoG requirements.

In an additional embodiment in which each of the partitions of first and second storage tanks 1740,1750 include firefighting agent, A may hold 536 gallons, B may hold 585 gallons, C may hold 567 gallons, D may hold 610 gallons, E may hold 542 gallons, F may hold 535 gallons, G may hold 531 gallons, and H may hold 594 gallons.

In embodiments including an aircraft and multiple storage tanks (such as those found in FIGS. 1, 11A, 12A, 16A, and 17A, for example), storage tanks may be positioned in a main deck of the aircraft while discharge ductings (including cylinders) may be positioned in a lower deck of the aircraft. In an additional embodiment, storage tanks may be positioned in a main deck of the aircraft, a first portion of discharge ductings may be positioned in the main deck of the aircraft, and a second portion of discharge ductings (including cylinders) may be positioned in a lower deck of the aircraft. In an additional embodiment, storage tanks may be positioned in a main deck of the aircraft, a first portion of discharge ductings (that do not include cylinders) may be positioned in the main deck of the aircraft, and a second portion of discharge ductings (only including cylinders) may be positioned in a lower deck of the aircraft.

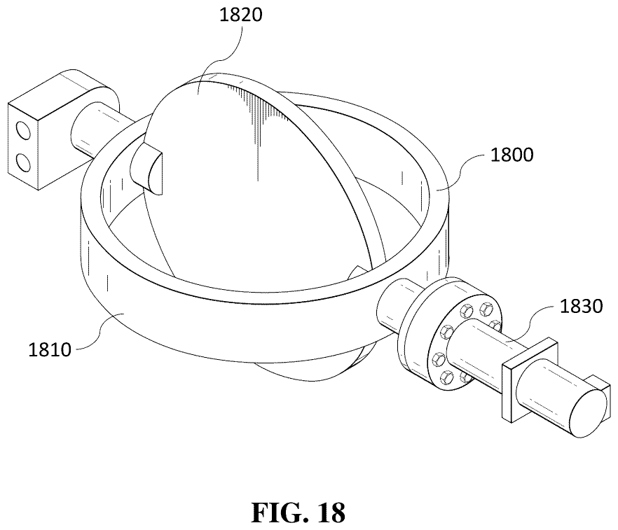

FIG. 18 is an illustration of a perspective view of a butterfly valve 1800 in accordance with certain embodiments of the present disclosure. As shown, butterfly valves, such as, for example butterfly valve 1800, in embodiments, may be utilized in one or both of aerial firefighting delivery system 1610 and/or aerial firefighting delivery system 1710. Butterfly valve 1800 includes a body 1810 housing within which a disc 1820 may rotate. A shaft 1830 is positioned through body 1810 and attaches to disc 1820 so that when a rotational force is applied to shaft 1830, disc 1820 is rotated as a result. Disc 1820 may rotate between a closed position (parallel to body 1810) and an open position (perpendicular to body 1810); disc 1820 may also rotate to be positioned in a partially open/partially closed configuration (between an open configuration and a closed configuration). Disc 1820 may also be rotated incrementally in order to provide flow control of firefighting agent. In an embodiment in which butterfly valve 1800 is closed, butterfly valve 1800 may be sealed using pneumatically pressurized seals around the periphery of body 1810. In an additional embodiment, the nominal diameter of the flow portion of butterfly valve 1800 may be 18 inches. In an additional embodiment, disc 1820 may comprise either of: an aerospace composite material or a high strength lightweight metal alloy. In an additional embodiment, butterfly valve 1800 may be actuated via electrical motors and reducing gearboxes. In this embodiment, motors may be controlled via a drop control computer that uses storage tank quantity information and a flight crew control panel for inputs in order to command the required valve positions via a real-time feedback loop.

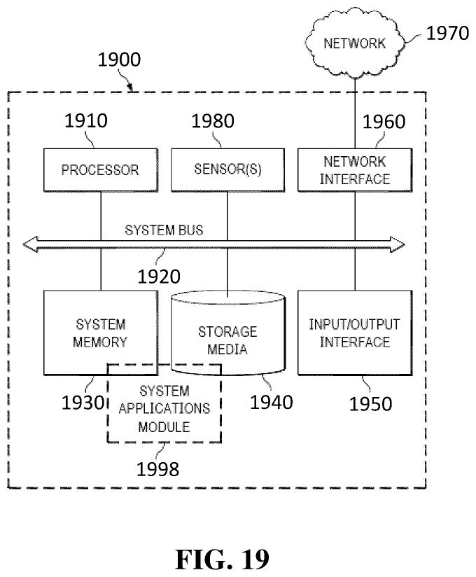

Referring now to FIG. 19, illustrated is a computing machine 1900 and a system applications module 1998, in accordance with example embodiments. The computing machine 1900 can correspond to any of the various computers, mobile devices, laptop computers, Internet of Things (IoT), servers, embedded systems, or computing systems presented herein. The module 1995 can comprise one or more hardware or software elements, e.g. other OS application and user and kernel space applications, designed to facilitate the computing machine 1900 in performing the various methods and processing functions presented herein. The computing machine 1900 can include various internal or attached components such as a processor 1910, system bus 1820, system memory 1930, storage media 1940, input/output interface 1950, a network interface 1960 for communicating with a network 1970, e.g. cellular/GPS, Bluetooth, WIFI, or Devicenet, EtherCAT, Analog, RS485, etc., and one or more sensors 1980.

The computing machines can be implemented as a conventional computer system, an embedded controller, a laptop, a server, a mobile device, a smartphone, a wearable computer, a customized machine, any other hardware platform, or any combination or multiplicity thereof. The computing machines can be a distributed system configured to function using multiple computing machines interconnected via a data network or bus system.

Processor 1910 can be designed to execute code instructions in order to perform the operations and functionality described herein, manage request flow and address mappings, and to perform calculations and generate commands. Processor 1910 can be configured to monitor and control the operation of the components in the computing machines. Processor 1910 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. Processor 1910 can be a single processing unit, multiple processing units, a single processing core, multiple processing cores, special purpose processing cores, co-processors, or any combination thereof. According to certain embodiments, processor 1910 along with other components of computing machine 1900 can be a software based or hardware based virtualized computing machine executing within one or more other computing machines.

The system memory 1930 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 1930 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 1930. The system memory 1930 can be implemented using a single memory module or multiple memory modules. While the system memory 1930 is depicted as being part of the computing machine, one skilled in the art will recognize that the system memory 1930 can be separate from the computing machine 1900 without departing from the scope of the subject technology. It should also be appreciated that the system memory 1930 can include, or operate in conjunction with, a non-volatile storage device such as the storage media 1940.

The storage media 1940 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 1940 can store one or more operating systems, application programs and program modules, data, or any other information. The storage media 1940 can be part of, or connected to, the computing machine. The storage media 1940 can also be part of one or more other computing machines that are in communication with the computing machine such as servers, database servers, cloud storage, network attached storage, and so forth.

The applications module 1998 and other OS application modules can comprise one or more hardware or software elements configured to facilitate the computing machine with performing the various methods and processing functions presented herein. The applications module 1998 and other OS application modules can include one or more algorithms or sequences of instructions stored as software or firmware in association with the system memory 1930, the storage media 1940 or both. The storage media 1940 can therefore represent examples of machine or computer readable media on which instructions or code can be stored for execution by the processor 1910. Machine or computer readable media can generally refer to any medium or media used to provide instructions to the processor 1910. Such machine or computer readable media associated with the applications module 1998 and other OS application modules can comprise a computer software product. It should be appreciated that a computer software product comprising the applications module 1998 and other OS application modules can also be associated with one or more processes or methods for delivering the applications module 1998 and other OS application modules to the computing machine via a network, any signal-bearing medium, or any other communication or delivery technology. The applications module 1998 and other OS application modules can also comprise hardware circuits or information for configuring hardware circuits such as microcode or configuration information for an FPGA or other PLD. In one exemplary embodiment, applications module 1998 and other OS application modules can include algorithms capable of performing the functional operations described by the flow charts (modes of operation) computer systems presented herein.

The input/output (“I/O”) interface 1950 can be configured to couple to one or more external devices, to receive data from the one or more external devices, and to send data to the one or more external devices. Such external devices along with the various internal devices can also be known as peripheral devices. The I/O interface 1950 can include both electrical and physical connections for coupling the various peripheral devices to the computing machine or the processor 1910. The I/O interface 1950 can be configured to communicate data, addresses, and control signals between the peripheral devices, the computing machine, or the processor 1910. The I/O interface 1950 can be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 1950 can be configured to implement only one interface or bus technology. Alternatively, the I/O interface 1950 can be configured to implement multiple interfaces or bus technologies. The I/O interface 1950 can be configured as part of, all of, or to operate in conjunction with, the system bus 1920. The I/O interface 1950 can include one or more buffers for buffering transmissions between one or more external devices, internal devices, the computing machine, or the processor 1920.

The I/O interface 1950 can couple the computing machine to various input devices including mice, touch-screens, scanners, electronic digitizers, sensors, receivers, touchpads, trackballs, cameras, microphones, keyboards, any other pointing devices, or any combinations thereof. The I/O interface 1950 can couple the computing machine to various output devices including video displays, speakers, printers, projectors, tactile feedback devices, automation control, robotic components, actuators, motors, fans, solenoids, valves, pumps, transmitters, signal emitters, lights, and so forth.

The computing machine 1900 can operate in a networked environment using logical connections through the NIC 1960 to one or more other systems or computing machines across a network. The network can include wide area networks (WAN), local area networks (LAN), intranets, the Internet, wireless access networks, wired networks, mobile networks, telephone networks, optical networks, or combinations thereof. The network can be packet switched, circuit switched, of any topology, and can use any communication protocol. Communication links within the network can involve various digital or an analog communication media such as fiber optic cables, free-space optics, waveguides, electrical conductors, wireless links, antennas, radio-frequency communications, and so forth.

The one or more sensors 1980 can be a position sensor and pressure sensors. The pressure sensor can be an Absolute Pressure (P) sensor or a Differential Pressure (DP) sensor. The position sensor can be a capacitive, optical, strain gauge, or magnetic sensor. The sensors 1980 can be traditional sensors or semiconductor based sensors.

The processor 1910 can be connected to the other elements of the computing machine 1900 or the various peripherals discussed herein through the system bus 1920. It should be appreciated that the system bus 1920 can be within the processor 1910, outside the processor 1910, or both. According to some embodiments, any of the processors 1910, the other elements of the computing machine 1900, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

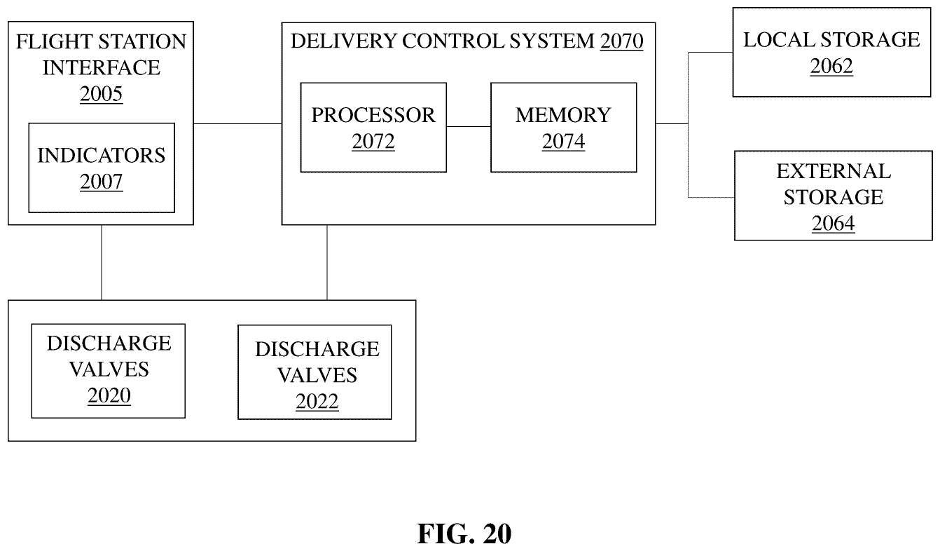

It is noted that any of the methods and systems disclosed below in FIG. 20 may be utilized/associated with any of the disclosed aircraft embodiments.

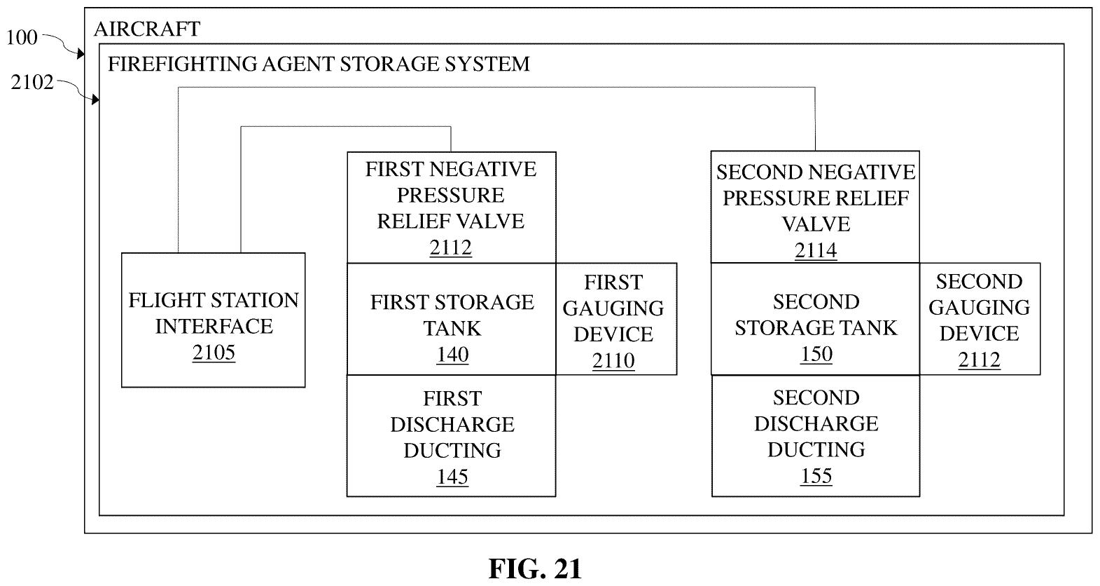

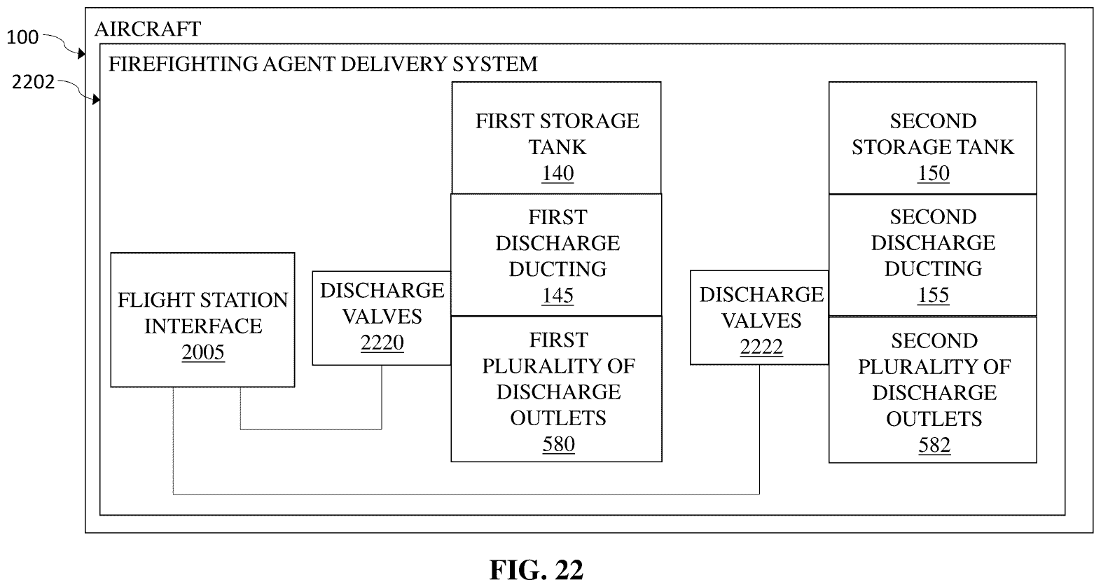

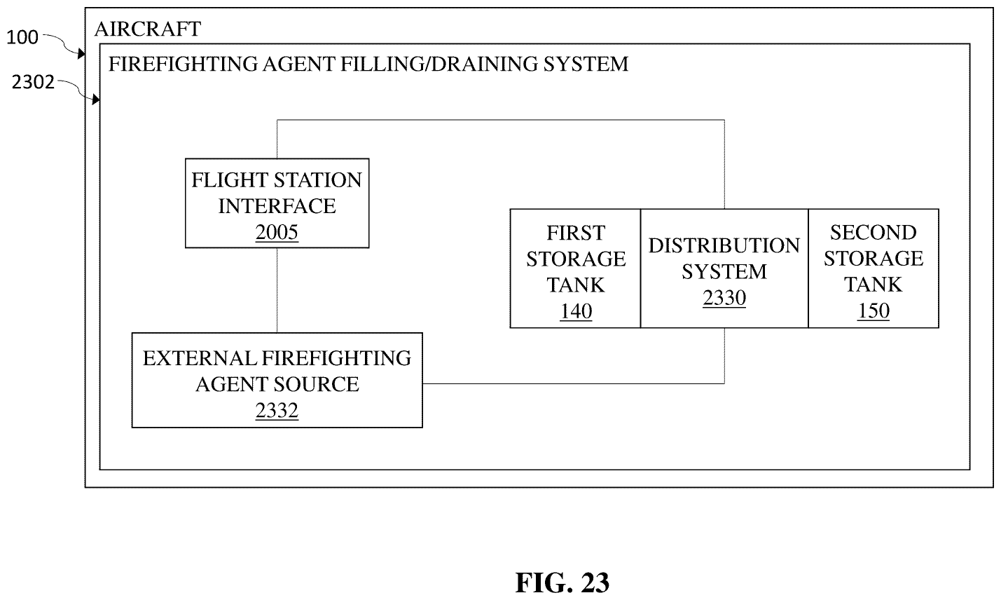

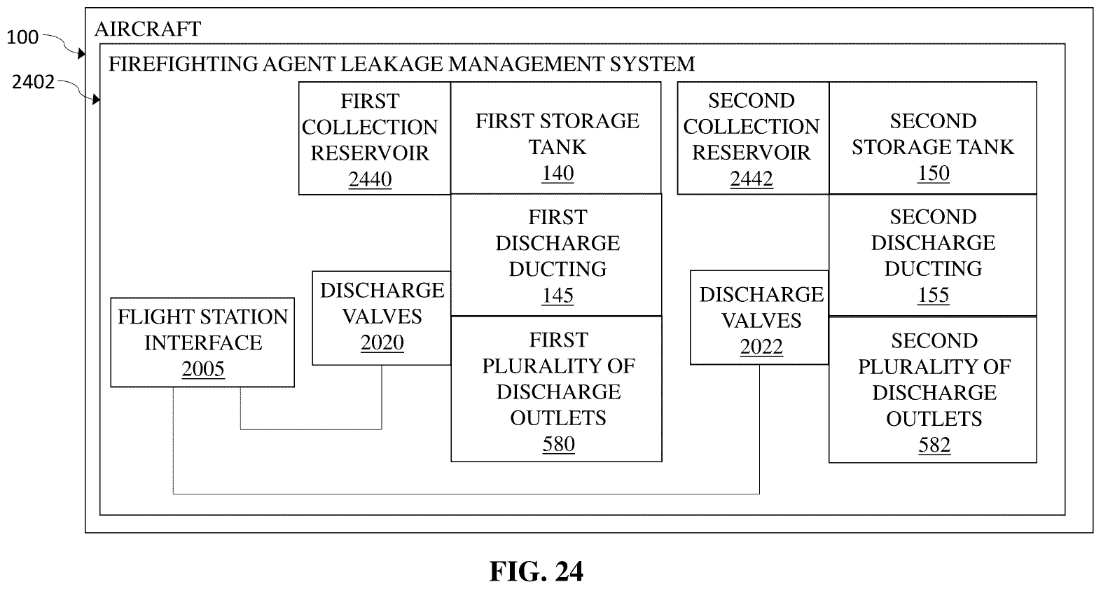

FIG. 20 is an illustration of a diagrammatic view of a delivery control system 2070 electrically connected to a flight station interface 2005 in accordance with certain embodiments of the present disclosure. As shown, delivery control system 2070 includes a processor 2072 and a memory 2074 (similar to system memory 1930 of FIG. 19) coupled to processor 2072, where memory 2074 is configured to store instructions. The instructions, when executed by processor 2072, causes processor 2072 to perform a number of operations relative to any of: firefighting agent storage system 2102 (of FIG. 21), firefighting agent delivery system 2202 (of FIG. 22), firefighting agent filling/draining system 2302 (of FIG. 23), and firefighting agent leakage management system 2402 (of FIG. 24).

In an embodiment, a method for dropping a firefighting agent during a flight (specifically, a flyover) of an aircraft using flight station interface 2005 and delivery control system 2070 is disclosed. The method includes arming the delivery control system using a toggle switch of delivery control system 2070. A user (pilot) then selects, via flight station interface 2005, a drop volume and a coverage level. Once the drop volume and coverage levels are chosen, feedback, gathered via one or more sensors electrically connected to delivery control system 2070 and an aerial firefighting delivery system, is provided to the user in the form of a status of delivery control system. In embodiments, the feedback may include indicators activated on flight station interface 2005 that indicate a status of one or more elements of storage tanks and may include, but are not limited to: a ready status, a fault status, a leakage status, a gallons on board measurement, a low drain accumulator level status for porting overboard. Once feedback is received and no action is needed to be made regarding any indicators, the user triggers the release of firefighting agent via continuous actuation of a drop button of flight station interface 2005. In certain embodiments, delivery/dispersal of firefighting agent may be automatically stopped once a set output is achieved.

In certain embodiments, flight station interface 2005 may include activatable indicators that provide information to the user. The indicators may provide information such as, but not limited to: a present tank quantity for either of the storage tanks, a density or weight of firefighting agent (via a head pressure sensor), a valve status (for example, operational or faulted), and a system status (for example, armed, operational, faulted, degraded, etc.).

In an embodiment, processor 2072 of delivery control system 2070 may execute instructions that cause processor 2072 to perform a number of operations relative to a preparation phase of an aerial firefighting delivery system. Operations may include, but are not limited to: controlling a filling sequence, monitoring a system status, checking a fluid quantity, computing a delivery system weight and a center of gravity position for takeoff and landing of an aircraft, accounting for fuel load, personnel weighing and balancing, and analyzing external factors that play into center of gravity and takeoff performance.

In an embodiment, processor 2072 of delivery control system 2070 may execute instructions that cause processor 2072 to perform a number of operations relative to an arming phase of an aerial firefighting delivery system. Operations may include, but are not limited to: allowing delivery/dispersing of firefighting agent via toggling of an arming switch in flight station interface 2070 and actuation of a drop button by a user, calculating an amount of firefighting agent requested, and sending the associated preparatory signal(s) to discharge valves 2220,2222 (of FIG. 22).

In an embodiment, processor 2072 of delivery control system 2070 may execute instructions that cause processor 2072 to perform a number of operations relative to a drop phase of an aerial firefighting delivery system. Operations may include, but are not limited to: activating the drop phase/sequence via identification of an actuation of drop buttons by two users (for example, pilot and copilot) located on two separate sidestick controllers, delivering commands to components of delivery control system 2070, adjusting discharge valves 2220,2222 as required in order to reach a targeted flow rate and quantity, and stopping delivery via analysis of delivery of a pre-selected quantity of firefighting agent (alternatively, a user/pilot can release a yoke button in order to carry out this operation). It is noted that in certain scenarios, if the pilot releases the drop button early (before a drop is finished) and then presses the drop button again, the drop may recommence and terminate normally.

In certain embodiments, delivery control system 2070 may comprise Built In Test Equipment (BITE) functionality configured to support system troubleshooting via maintenance personnel when servicing an aerial firefighting delivery system. The BITE functionality may include a configuration to actuate discharge valves 2220,2222 individually for diagnostic purposes and may further be configured to analyze readings and outputs from level sensors, flow meters, and other portions of delivery control system 2070. In other embodiments, deliver control system 2070 may be configured to record drop parameters for later recovery in support of system troubleshooting (utilizing either of local storage 2062 or external storage 2064).

It is noted that the USFS requires that all firefighting aircraft continuously record flight parameters and statuses of an aerial firefighting delivery system during operation. Per the requirements, some of this data may be archived locally (for example, via local storage 2062) while other information related to drop volumes and locations is provided as telemetry in real-time to the USFS ATIS system (external storage 2064). Besides drop data, the requirements state that data on flight parameters must also be provided in the data stream. This includes approximately 30 separate data channels. A large amount of this flight data will already be available on ARINC data buses (local storage 2062) in an aircraft. Archived data, per the requirements, must be uploaded to the USFS servers and on-ground servers (external storage 2064) periodically using Wi-Fi or cellular connections. Also, in regard to minimum required parameters and instrumentation to be recorded, requirements are described in the USDA-Forest Service, Special Mission Airworthiness Assurance Guide (released on Nov. 6, 2015) and/or the current USFS MATOC requirements.

In embodiments, delivery control system 2070 may utilize information (inputs) from sensors installed on firefighting agent storage system 2102 and firefighting agent delivery system 2202. Information received from the sensors may include, but is not limited to: tank level indication (via multiple sensors such as float-type sensors or RF (radar) type sensors), flow rate indication (via multiple sensors, located within each outlet of first and second pluralities of discharge outlets; sensor may include paddlewheel sensors, other doppler based sensors, or mass flow rate sensors), valve position indication and any other status indication related to the valves (for example, seal status and sealing air pressure if utilized), head pressure in lower tank sensing (when combined with level indication, this can be used to determine weight & density of the firefighting agent; this information should be provided to the flight crew), and ground speed sensing (GPS) (this signal is used to adjust target flow rates in case of variations of speed from optimal to obtain nominal ground patterns regardless of speed variations; GPS signals additionally provide time stamps for data recording).

In an embodiment, in relation to an emergency dump scenario, processor 2072 of delivery control system 2070 may execute instructions that cause processor 2072 to perform an operation including: executing the opening of all discharge valves (discharge valves 2220,2222) via independent control means and multiple redundant power sources. For this scenario, flight station interface 2005 includes a separate emergency drop switch that, when actuated, can instantly jettison the load of the aircraft.

It is noted that embodiments of methods and system disclosed in FIGS. 21-24 may disclose and/or utilize specific embodiments of aircrafts and components (such as, for example, aircraft 100). The disclosure/utilization of the components are exemplary only and may be interchangeable with other aircraft embodiments/aircraft components.

FIG. 21 is an illustration of a diagrammatic view of a firefighting agent storage system 2102 in accordance with certain embodiments of the present disclosure. A first storage tank 140 including a first discharge ducting 145 and a second storage tank 150 including a second discharge ducting 155 are installed on aircraft 100, as shown similarly in FIG. 1. The installation of tanks 140,150 on main deck 122, as shown, provides a maximum head height and improves flow performance of firefighting agent when dropped. Tanks 140,150 also include respective first and second gauging devices 2110,2112 that are each configured to perform functions such as, but not limited to: providing a determination of a firefighting agent volume and a rate of change, detecting critical leakages and leakage rates, and detecting malfunctioning release valves. A s further shown, tanks 140,150 include respective first and second negative pressure release valves 2112,2114 each having sensors for detecting stuck or malfunctioning valves. It is noted that first and second gauging devices 2110,2112 and first and second negative pressure release valves 2112,2114 are electrically connected to delivery control system 2070 in order to send a signal to delivery control system relative to the aforementioned functions. Delivery control system 2070 may then relay the signals to flight station interface, where the signals are configured to activate indicators for informing pilots of aircraft 100 of a potential issue or malfunction. In regard to firefighting agent storage system 2102, indicators can include, but are not limited to: valve status indicators, tank quantity indicators, rate of change indicators, and leakage indicators.

FIG. 22 is an illustration of a diagrammatic view of a firefighting agent delivery system 2202 in accordance with certain embodiments of the present disclosure. In this embodiment, a first storage tank 140 includes a first discharge ducting 145 and a first plurality of discharge outlets 580 and a second storage tank 150 includes a second discharge ducting 155 and a second plurality of discharge outlets 580 installed on aircraft 100, as shown similarly in FIGS. 1, 5C, and 5D. As disclosed, first discharge ducting 145 and first plurality of discharge outlets 580 embodies generally the same configuration as second discharge ducting 155 and second plurality of discharge outlets 580 in order to provide efficient dropping of firefighting agent. During a drop, in embodiments, a flow rate of firefighting agent during a drop may reach up to 1600 gallons per second. First and second discharge ducting 145,155 further include respective discharge valves 2220,2222 positioned above respective first and second pluralities of discharge outlets 580,582. Discharge valves 2220,2222 are electrically connected to flight station interface 2005 and may receive from flight station interface 2005, via delivery control system 2070, a signal to open or close. In additional embodiments, discharge valves 2220,2222 may receive a signal to open during an emergency drop situation. It is further noted that, in embodiments, first and second discharge ducting 145,155 and discharge valves 2220,2222 may be compatible with any firefighting agent without excessive regular maintenance or refurbishing.

FIG. 23 is an illustration of a diagrammatic view of a firefighting agent filling/draining system 2302 in accordance with certain embodiments of the present disclosure. In this embodiment, first storage tank 140 and second storage tank 150 are affixed to a distribution system 2330 that is configured to conveniently and efficiently load and offload firefighting agent to and from first storage tank 140 and second storage tank 150 when aircraft 100 is on the ground. In an embodiment, distribution system 2330 may utilize a standard USFS tanker base system capable of filling first storage tank 140 and second storage tank 150 simultaneously and within 10 to 20 minutes at a flow rate of 500 gallons per minute. In order to supply firefighting agent to distribution system 2330, distribution system 2330 may be connected to, via a ground connector (for example a three inch diameter “camloc” connector), an external firefighting agent source 2332. It is noted that in certain offloading scenarios, a volume of firefighting retardant in each of tanks 140,150 will not exceed 100 gallons so that aerial firefighting delivery system 110 may be effectively utilized.

In order to avoid scenarios of overfilling and spilling, firefighting agent filling/draining system 2302 may incorporate sensors that are configured to measure and monitor the firefighting agent level inside tanks 140,150 during refilling. These sensors may be affixed to either of distribution system 2330 or tanks 140,150 and are electrically connected to delivery control system 2070 in order to provide measurement data that may be converted into indicator signals for flight station interface 2005. In the event of an overfilling, means may be provided for discharging the excess fluid overboard without detrimental effects or requirement for subsequent maintenance actions.

FIG. 24 is an illustration of a diagrammatic view of a firefighting agent leakage management system 2402 in accordance with certain embodiments of the present disclosure. In this embodiment, first storage tank 140 and second storage tank 150 are affixed to respective first and second collection reservoirs 2440,2442 that is configured to assist in offloading captured firefighting agent from tank 140 and/or 150 when a leak occurs. Sensors affixed to first and second collection reservoirs 2440,2442 may detect and send signals to flight station interface 2005, via delivery control system 2070, in order to activate indicators that inform pilots of aircraft 100 that collection reservoirs 2440,2442 are full or have reached a certain limit. Once identified, the excess firefighting agent may be ported using discharge valves 2220,2222. In certain embodiments, porting of firefighting agent from collection reservoirs 2440,2442 may occur automatically. In regard to a ground overfill scenario, aircraft 100 may be configured to port excess or accumulated overfill firefighting agent overboard.

In additional embodiments, an OLM (Operational Load Monitoring) system may be installed on an aircraft that is configured to provide and record information on a load's environment encountered by the aircraft. Overall, the OLM system may provide real-time notifications to owners of the aircraft if any load parameters are exceeded (for example, exceedance of airframe G-limits, flap limiting airspeeds, etc.). OLM system may also be configured to support a FOQA program by flagging relevant incidents (for example, max bank angles, low fuel arrivals, unstable approaches, etc.). Additionally, a first aircraft to enter service that includes aerial firefighting delivery system 110 must include a suite of strain gauges installed in order to provide additional load monitoring to meet USFS requirements. A location and number of strain gauges may be determined in consultation with a structural integrity program partner.

It is noted that in order for an aerial firefighting delivery system to be utilized effectively and without threatening the integrity of a disclosed aircraft, both storage tanks may be drained at the same time. In order to avoid a scenario where only one of storage tanks drains, a first set of controls electrically connected to discharge valves 2220 and a second set of controls electrically connected to discharge valves 2222 may both be actuated in order to make sure that all discharge outlets open appropriately when needed. It is noted that it would be difficult to utilize a single set of controls via a mechanical linkage for this task due to the large spacing between discharge outlets. In addition, using a single set of controls would also provide ineffective flow control since the separate tanks will flow differently. Overall, utilizing a first set of controls electrically connected to discharge valves 2220 and a second set of controls electrically connected to discharge valves 2222 to control discharge valves 2220,2222 individually is advantageous because it provides more effective control of the firefighting agent and better tank performance for USFS certification purposes.

In embodiments, each of the two separate sets of controls to control discharge valves 2220,2222 separately may further include a command-monitoring architecture for certification purposes. The command-monitoring architecture may include the use of two separate controllers, one configured to control a drop and another configured to monitor storage tanks for anomalies. The monitoring system (the two separate sets of controls and two separate controllers), in further embodiments, may be configured to command all valves to open fully if an anomaly is detected. In addition, basic system redundancy in the form of multiple power sources and multiple drop valves are utilized and must be confirmed by appropriate FMEA analyses. In regard to this configuration, this configuration amounts to a “drop-by-wire” system.

In additional embodiments, a standard ECM (engine condition monitoring) system may be installed on any of the disclosed aircrafts.

In embodiments, any of the disclosed first and second storage tanks may comprise anti-sloshing devices that may be installed within the volume of the first and second storage tanks and may include one or more of: baffle plates, foam, and bladder tanks.

In embodiments, as configured, the disclosed storage tanks provide a number of beneficial aspects to the disclosed aerial firefighting delivery systems. For example, the construction of the storage tanks may provide the following: the ability for an aircraft to reach a maximum aircraft weight capacity when the storage tanks are filled with firefighting agent, the ability to maximize flow stability and quality of firefighting agent during a drop while also keeping the firefighting agent mono-phasic, the capability for the storage tanks to accept any type of firefighting agent (such as water or fire retardant, for example) without a need for regular maintenance or refurbishing, the capability to ensure venting to/from the ambient during refilling and defiling by passive means, the capability to ensure venting from the ambient in the case of gravity drop by passive means, the capability to minimize detrimental effects due to firefighting agent sloshing and aggressive aircraft maneuvering of the firefighting agent. In regard to the design of the disclosed discharge ductings, as well as any associated brackets, the discharge ductings are configured to withstand internal fluid, fluid reaction forces, and externally induced forces in normal and abnormal conditions.

In embodiments, the disclosed discharge ductings may include vertical piping vertically aligned with and adjacent to the disclosed discharge outlets. The lack of horizontal piping may be utilized to minimize flow loss when firefighting agent is dropped. In the embodiments disclosed, the configurations of aerial firefighting delivery systems may utilize gravity in order to discharge firefighting agent from and during any aircraft configurations and conditions.

For the purposes of this disclosure, the term “full”, in relation to storage tanks, may refer to either of: a storage tank's total capacity or a storage tank's capacity that is less than the total capacity of the storage tank.

For the purposes of this disclosure, the terms “first storage tank”, “fwd storage tank”, and “forward storage tank” may be synonymous, unless noted otherwise. Additionally, the terms “second storage tank” and “aft storage tank” may be synonymous, unless noted otherwise.

In embodiments, an aircraft utilized to carry any of the disclosed aerial firefighting delivery systems (and carry out the associated functions) may embody either of a narrow or a wide body airplane design. Exemplary airplane models include, but are not limited to: Airbus 318, 319, 320, 321, and 330 series; ATR 42 & 72 series; BAE systems BAE-146 and RJ series; Boeing 717, 727, 737, 747, 757, 767, 777, DC-10, MD-11 and C-17 series; deHavilland DHC-8 and Q400 series; Embraer C-390 series; Leonardo C-27 series; and Lockheed C-130, P-3, L188 and L100 series.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, an aircraft for carrying and dispersing one or more firefighting agents, comprising: a fuselage defining an interior space within the aircraft, the fuselage bisected into a main deck and a lower deck; a pair of wings coupled to the fuselage, wherein a first wing is disposed on a first side of the fuselage and a second wing is disposed on a second side of the fuselage; a first storage tank positioned within the main deck and forward of the pair of wings; a second storage tank positioned within the main deck and aft of the pair of wings; a first discharge ducting positioned in the lower deck, the first discharge ducting fluidly connecting the first storage tank to a first plurality of discharge outlets disposed in an underbelly of the fuselage; and a second discharge ducting positioned in the lower deck, the second discharge ducting fluidly connecting the second storage tank to a second plurality of discharge outlets disposed in the underbelly of the fuselage.

Clause 2, the aircraft of Clause 1, wherein each of the first storage tank and the second storage tank comprise at least one of the one or more firefighting agents selected from: water or fire retardant.

Clause 3, the aircraft of Clause 1, further comprising a valve positioned within each of the first plurality of discharge outlets and the second plurality of discharge outlets.

Clause 4, the aircraft of Clause 3, wherein each of the plurality of valves comprises a butterfly valve.

Clause 5, the aircraft of Clause 1, wherein the first plurality of discharge outlets and the second plurality of discharge outlets are positioned along a plane axis extending from a nose to a tail of the aircraft, further wherein the one or more firefighting agents disbursed from the first plurality of discharge outlets and the second plurality of discharge outlets define a flow path of the one or more firefighting agents aligned along the plane axis.

Clause 6, the aircraft of Clause 5, further comprising a wing-to-body fairing having a pack inlet positioned along the flow path.

Clause 7, the aircraft of Clause 6, further comprising an S-shaped air duct affixed to the pack inlet, the S-shaped air duct defining an air inlet positioned outside of the flow path of the one or more firefighting agents.

Clause 8, the aircraft of Clause 1, further comprising at least one RADALT antenna affixed to an underbelly of the aircraft and positioned along the flow path of the one or more firefighting agents, wherein a curved fairing at least partially surrounds each of the at least one RADALT antenna for shielding each of the at least one RADALT antenna from the one or more firefighting agents.

Clause 9, the aircraft of Clause 1, wherein each of the at least one curved fairing comprises a drip edge for retarding flow of the one or more firefighting agents above a top end of each of the at least one curved fairing.

Clause 10, the aircraft of Clause 1, further comprising one or more securement elements affixed to each of the first storage tank, the second storage tank, and the aircraft.

Clause 11, the aircraft of Clause 1, wherein each of the first plurality of discharge outlets and the second plurality of discharge outlets comprise a discharge valve coupled to a delivery control system.

Clause 12, the aircraft of Clause 1, wherein entireties of each of the first discharge ducting and the second discharge ducting are vertically constructed.

Clause 13, an aerial firefighting delivery system, comprising: a first storage tank positioned within a main deck of an aircraft and forward of a pair of wings of the aircraft; a second storage tank positioned within the main deck and aft of the pair of wings; a first discharge ducting positioned in a lower deck of the aircraft, the first discharge ducting fluidly connecting the first storage tank to a first plurality of discharge outlets disposed in an underbelly of the aircraft; and a second discharge ducting positioned in the lower deck, the second discharge ducting fluidly connecting the second storage tank to a second plurality of discharge outlets disposed in the underbelly.

Clause 14, the system of Clause 13, wherein each of the first storage tank and the second storage tank comprise at least one of the one or more firefighting agents selected from: water or fire retardant.

Clause 15, the system of Clause 13, further comprising a valve positioned within each of the first plurality of discharge outlets and the second plurality of discharge outlets.

Clause 16, the system of Clause 15, wherein each of the plurality of valves comprises a butterfly valve.

Clause 17, the system of Clause 13, wherein the first plurality of discharge outlets and the second plurality of discharge outlets are positioned along a plane axis extending from a nose to a tail of the aircraft, further wherein the one or more firefighting agents disbursed from the first plurality of discharge outlets and the second plurality of discharge outlets define a flow path of the one or more firefighting agents aligned along the plane axis.

Clause 18, the system of Clause 13, wherein each of the first plurality of discharge outlets and the second plurality of discharge outlets comprise four discharge outlets.

Clause 19, the system of Clause 13, further comprising one or more securement elements affixed to each of the first storage tank, the second storage tank, and the aircraft.

Clause 20, the system of Clause 13, wherein each of the first plurality of discharge outlets and the second plurality of discharge outlets comprise a discharge valve coupled to a delivery control system.

Clause 21, the system of Clause 10, wherein the discharge valves of the first plurality of discharge outlets and the discharge valves of the first plurality of discharge outlets are independently controlled via respective control systems.

What is claimed is:

1. An aircraft for carrying and dispersing one or more firefighting agents, comprising:
a fuselage defining an interior space within the aircraft, the fuselage bisected into a main deck and a lower deck;
a pair of wings coupled to the fuselage, wherein a first wing is disposed on a first side of the fuselage and a second wing is disposed on a second side of the fuselage;
a first storage tank positioned within the main deck and forward of the pair of wings;
a second storage tank positioned within the main deck and aft of the pair of wings;
a first discharge ducting positioned in the lower deck, the first discharge ducting fluidly connecting the first storage tank to a first plurality of discharge outlets disposed in an underbelly of the fuselage;
and
a second discharge ducting positioned in the lower deck, the second discharge ducting fluidly connecting the second storage tank to a second plurality of discharge outlets disposed in the underbelly of the fuselage.

2. The aircraft of claim 1, wherein each of the first storage tank and the second storage tank comprise at least one of the one or more firefighting agents selected from: water or fire retardant.

3. The aircraft of claim 1, further comprising a valve positioned within each of the first plurality of discharge outlets and the second plurality of discharge outlets.

4. The aircraft of claim 3, wherein each of the plurality of valves comprises a butterfly valve.

5. The aircraft of claim 1, wherein the first plurality of discharge outlets and the second plurality of discharge outlets are positioned along a plane axis extending from a nose to a tail of the aircraft, further wherein the one or more firefighting agents disbursed from the first plurality of discharge outlets and the second plurality of discharge outlets define a flow path of the one or more firefighting agents aligned along the plane axis.

6. The aircraft of claim 5, further comprising a wing-to-body fairing having a pack inlet positioned along the flow path.

7. The aircraft of claim 6, further comprising an S-shaped air duct affixed to the pack inlet, the S-shaped air duct defining an air inlet positioned outside of the flow path of the one or more firefighting agents.

8. The aircraft of claim 1, further comprising at least one RADALT antenna affixed to an underbelly of the aircraft and positioned along the flow path of the one or more firefighting agents, wherein a curved fairing at least partially surrounds each of the at least one RADALT antenna for shielding each of the at least one RADALT antenna from the one or more firefighting agents.

9. The aircraft of claim 1, wherein each of the at least one curved fairing comprises a drip edge for retarding flow of the one or more firefighting agents above a top end of each of the at least one curved fairing.

10. The aircraft of claim 1, further comprising one or more securement elements affixed to each of the first storage tank, the second storage tank, and the aircraft.

11. The aircraft of claim 1, wherein each of the first plurality of discharge outlets and the second plurality of discharge outlets comprise a discharge valve coupled to a delivery control system.

12. The aircraft of claim 1, wherein entireties of each of the first discharge ducting and the second discharge ducting are vertically constructed.

13. An aerial firefighting delivery system, comprising:
a first storage tank positioned within a main deck of an aircraft and forward of a pair of wings of the aircraft;
a second storage tank positioned within the main deck and aft of the pair of wings;
a first discharge ducting positioned in a lower deck of the aircraft, the first discharge ducting fluidly connecting the first storage tank to a first plurality of discharge outlets disposed in an underbelly of the aircraft;
and
a second discharge ducting positioned in the lower deck, the second discharge ducting fluidly connecting the second storage tank to a second plurality of discharge outlets disposed in the underbelly.

14. The system of claim 13, wherein each of the first storage tank and the second storage tank comprise at least one of the one or more firefighting agents selected from: water or fire retardant.

15. The system of claim 13, further comprising a valve positioned within each of the first plurality of discharge outlets and the second plurality of discharge outlets.

16. The system of claim 15, wherein each of the plurality of valves comprises a butterfly valve.

17. The system of claim 13, wherein the first plurality of discharge outlets and the second plurality of discharge outlets are positioned along a plane axis extending from a nose to a tail of the aircraft, further wherein the one or more firefighting agents disbursed from the first plurality of discharge outlets and the second plurality of discharge outlets define a flow path of the one or more firefighting agents aligned along the plane axis.

18. The system of claim 13, wherein each of the first plurality of discharge outlets and the second plurality of discharge outlets comprise four discharge outlets.

19. The system of claim 13, further comprising one or more securement elements affixed to each of the first storage tank, the second storage tank, and the aircraft.

20. The system of claim 13, wherein each of the first plurality of discharge outlets and the second plurality of discharge outlets comprise a discharge valve coupled to a delivery control system.

21. The system of claim 10, wherein the discharge valves of the first plurality of discharge outlets and the discharge valves of the first plurality of discharge outlets are independently controlled via respective control systems.
